(19) United States
(12) Patent Application Publication
(10) Pub. No.: US 2026/0330031 A1
(43) Pub. Date: Oct. 22, 2026

(54) PROTECTING AGAINST DATA EXFILTRATION IN A DEDUPLICATION FILESYSTEM

(71) Applicant: Dell Products L.P., Round Rock, TX (US)

(72) Inventors: Nitin Madan, San Jose, CA (US); Abhishek Rajimwale, San Jose, CA (US); Mahadev Karadigudda, San Jose, CA (US); Srisailendra Yallapragada, Cupertino, CA (US)

(21) Appl. No.: 19/186,583

(22) Filed: Apr. 22, 2025

(51) Int. Cl. G06F 21/60; G06F 11/14; G06F 21/62

(52) U.S. Cl. CPC G06F 21/602; G06F 11/1451; G06F 21/6227

(57) ABSTRACT

A client is backed up by reading encrypted data segments from primary storage into a secure deduplication library installed at the client. The primary storage includes first data-at-rest-encryption (DARE) storage. The encrypted data segments are decrypted. The now unencrypted data segments are deduplicated against existing data segments being managed by a data protection appliance, connected to the client, to identify new data segments. The new data segments are encrypted and transmitted to the data protection appliance. The appliance includes a deduplication filesystem including a secure deduplication layer above a storage layer including a second DARE storage. Upon the secure deduplication layer receiving the encrypted new data segments, the data segments are decrypted, packed into storage containers, and written to the second DARE storage.

### TECHNICAL FIELD

The present invention relates generally to information processing systems, and more particularly to large scale filesystems.

### BACKGROUND

A deduplication filesystem is a type of filesystem that seeks to reduce the amount of redundant data that is stored by storing only a single copy of data rather than multiple redundant copies. A deduplicated filesystem can be especially effective in backup systems because of the reduction in the number of duplicate copies of data that are stored in a storage system.

Encryption refers to a technique where data is scrambled, thereby rending the data unreadable to unauthorized users. Encrypting data is important because it helps protect confidentiality, integrity, and security. Data in an encrypted format, however, does not deduplicate.

There is a need for improved systems and techniques to handle encryption in conjunction with a deduplication filesystem to reduce data storage consumption while also securing the data.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY

A client is backed up by reading encrypted data segments from primary storage into a secure deduplication library installed at the client. The primary storage includes first data-at-rest-encryption (DARE) storage. The encrypted data segments are decrypted. The now unencrypted data segments are deduplicated against existing data segments being managed by a data protection appliance, connected to the client, to identify new data segments. The new data segments are encrypted and transmitted to the data protection appliance. The appliance includes a deduplication filesystem including a secure deduplication layer above a storage layer including a second DARE storage. Upon the secure deduplication layer receiving the encrypted new data segments, the data segments are decrypted, packed into storage containers, and written to the second DARE storage.

### BRIEF DESCRIPTION OF THE FIGURES

In the following drawings like reference numerals designate like structural elements. Although the figures depict various examples, the one or more embodiments and implementations described herein are not limited to the examples depicted in the figures.

FIG. 1 shows a block diagram of an information processing system having a deduplication filesystem that facilitates protection against data exfiltration while achieving deduplication and cyber resiliency, according to one or more embodiments.

FIG. 2 shows an example of a deduplication process, according to one or more embodiments.

FIG. 3 shows an example of a tree data structure of the namespace, according to one or more embodiments.

FIG. 4 shows layer diagram of the filesystem, according to one or more embodiments.

FIG. 5 shows a block diagram of a backup or ingest, according to one or more embodiments.

FIG. 6 shows a block diagram of another backup or ingest, according to one or more embodiments.

FIG. 7 shows a block diagram of a restoration, according to one or more embodiments.

FIG. 8 shows a more detailed stack or layer diagram of a deduplication filesystem, according to one or more embodiments.

FIG. 9 shows a block diagram of a secure deduplication client library, according to one or more embodiments.

FIG. 10 shows a block diagram of a bad actor attempting to read from a secure deduplication system, according to one or more embodiments.

FIG. 11 shows a block diagram for ingest, according to one or more embodiments.

FIG. 12 shows a flow for ingest, according to one or more embodiments.

FIG. 13 shows a block diagram for a restoration, according to one or more embodiments.

FIG. 14 shows a flow for restoration, according to one or more embodiments.

FIG. 15 shows a block diagram of an ingestion operation using an external key manager system (EKMS), according to one or more embodiments.

FIG. 16 shows a flow for an ingestion operation using an EKMS, according to one or more embodiments.

FIG. 17 shows a block diagram of a restoration using an EKMS, according to one or more embodiments.

FIG. 18 shows a flow for restoration using an EKMS, according to one or more embodiments.

FIG. 19 shows a block diagram for granular encryption, according to one or more embodiments.

FIG. 20 shows a flow for granular encryption, according to one or more embodiments.

FIG. 21 shows a block diagram of an inode, according to one or more embodiments.

FIG. 22 shows a block diagram of secure deduplication and disaster recovery, according to one or more embodiments.

FIG. 23 shows a flow for secure deduplication and disaster recovery, according to one or more embodiments.

FIG. 24 shows a block diagram of disaster recovery using secure deduplication and an EKMS, according to one or more embodiments.

FIG. 25 shows a flow for disaster recovery using secure deduplication and an EKMS, according to one or more embodiments.

FIG. 26 shows a block diagram of secure deduplication with a cyber recovery vault, according to one or more embodiments.

FIG. 27 shows a flow for secure deduplication with a cyber recovery vault, according to one or more embodiments.

FIG. 28 shows a block diagram of cyber recovery and secure deduplication with an EKMS, according to one or more embodiments.

FIG. 29 shows a flow for cyber recovery and secure deduplication with an EKMS, according to one or more embodiments.

FIG. 30 shows a block diagram of cyber recovery with secure deduplication and a vault-internal EKMS, according to one or more embodiments.

FIG. 31 shows a flow for cyber recovery with secure deduplication and a vault-internal EKMS, according to one or more embodiments.

FIG. 32 shows a block diagram for configuration of a protection storage appliance for a vault, according to one or more embodiments.

FIG. 33 shows a block diagram of a protection storage appliance in a vault, according to one or more embodiments.

FIG. 34 shows a flow for a protection storage appliance in a vault, according to one or more embodiments.

FIG. 35 shows a block diagram of a processing platform that may be utilized to implement at least a portion of an information processing system, according to one or more embodiments.

FIG. 36 shows a block diagram of a computer system suitable for use with the system, according to one or more embodiments.

### DETAILED DESCRIPTION

A detailed description of one or more embodiments is provided below along with accompanying figures that illustrate the principles of the described embodiments. While aspects of the invention are described in conjunction with such embodiment(s), it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general purpose computer or be hardwired or hard coded in hardware such that when the software is loaded into and/or executed by the computer, the computer becomes an apparatus for practicing the invention. Applications may also be downloaded, in whole or in part, through the use of a software development kit or toolkit that enables the creation and implementation of the described embodiments. In this specification, these implementations, or any other form that the invention may take, may be referred to as techniques. In general, the order of the steps of disclosed processes may be altered within the scope of the invention. Aspects of the one or more embodiments described herein may be implemented on one or more computers executing software instructions, and the computers may be networked in a client-server arrangement or similar distributed computer network. In this disclosure, the variable N and other similar index variables are assumed to be arbitrary positive integers greater than or equal to two. It should be appreciated that the blocks, components, and modules shown in the figures may be functional and there can be many different hardware configurations, software configurations, or both to implement the functions described.

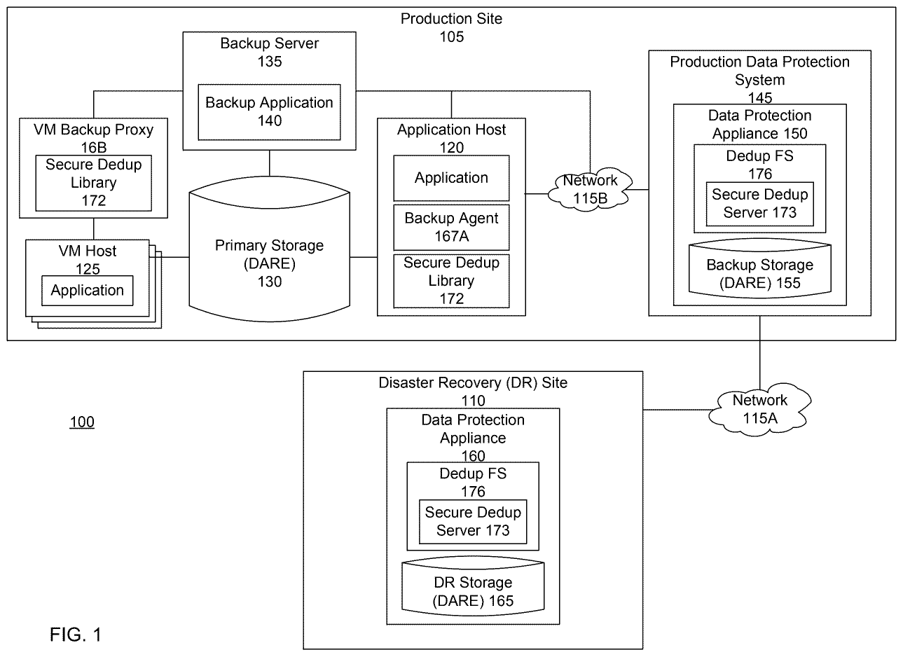

FIG. 1 shows a block diagram of an information processing system 100 within which methods and systems for protecting against data exfiltration while achieving deduplication and cyber resiliency may be implemented. Data exfiltration refers to the unauthorized transfer, leakage, or theft of data from a computer, network, or system to an external destination. It is a serious cybersecurity threat where sensitive or confidential information is intentionally or unintentionally taken out of an organization's controlled environment.

The example shown in FIG. 1 includes a customer organization's production site 105 and a disaster recovery (DR) site 110, geographically remote from the production site, and connected by a network 115A. Network 115A may be a wide area network (WAN).

The production site includes any number of clients such as client or application hosts 120 and virtual machines (VMs) 125, an underlying primary storage system 130, backup server 135 having backup application 140, and a production data protection or primary backup system 145. The backup system includes a data protection appliance 150 having a production backup storage 155. Backup storage may be referred to as protection storage. A network 115B connects the clients and backup server to data protection appliance 150. The disaster recovery site likewise includes a data protection appliance 160 having a disaster recovery storage 165. In an embodiment, backups maintained by the primary backup system are replicated to the data protection appliance at the disaster recovery site. The disaster recovery site may include additional protections to further safeguard the replicated backups. Such safeguards may include scanning the replicated backups for malware, placing the appliance within a vault that is connected via an air gap to the primary backup system, or both.

In an embodiment, data residing at each underlying storage system including the primary storage, backup storage, and disaster recovery storage systems is kept or maintained in an encrypted format using data-at-rest-encryption (D@RE or DARE). DARE is a process of encrypting stored or inactive data (e.g., data not actively being transmitted or processed) to protect it from unauthorized access. Data may be encrypted at the block/device level regardless of the filesystem structure. Applying DARE may be handled by the respective underlying storage system.

The clients host applications that are used by the organization. Some examples of applications include filesystems, databases, customer relationship management (CRM) systems, email and collaboration applications, and others. The clients and applications generate data (e.g., files or other units of data) that is stored in primary storage.

The backup application coordinates with backup agents or proxy agents 167A, B, respectively, installed at the clients to backup data stored in the primary storage to the production data protection appliance. In an embodiment, the backup application provides a management interface to configure backup schedules, identify data (e.g., directories and files) for backup, direct replication operations from the production data protection system to the disaster recovery site, set configuration options, and perform other administrative tasks. Backups (and replications) may be conducted automatically according to a backup or replication schedule. For example, backups may be scheduled to occur every 15, 30, or 60 minutes, daily, or any other frequency as desired. Backups of files and other data may be stored in a format that is different from a native format of the primary file copies in primary storage of the clients. For example, backups may be stored in a compressed format, encrypted format, deduplicated format, or combinations of these.

In an embodiment, secure deduplication libraries 172 are installed at the clients or backup proxies to protect backup and restoration operations and facilitate deduplication. A secure deduplication library may be referred to as a client-side secure deduplication library or SecureDedup client library. The client-side secure deduplication library may be positioned between the client application and data protection appliance and exposes an interface to the client application through which services of the data protection appliance may be made available.

In an embodiment, the client-side secure deduplication library includes an additional library (e.g., DDBoost library) that provides a proprietary protocol that allows the application to take advantage of storage and network efficiencies offered by the deduplication filesystem during backup and restoration operations. The protocol is custom-built to handle the specific use cases related to backup and restoration. The client-side library may be provided as a plug-in that presents a standard filesystem mount point to the application. The client-side library, however, is optional and may not be included in some embodiments. In an embodiment, the filesystem supports other file transfer protocols for accessing files through a network. Such protocols include Network File System (NFS) and Common Internet File System (CIFS). These protocols may be referred to as public protocols or standard protocols. Such protocols may be tied to specific organizations or developed through collaboration between organizations.

In an embodiment, the client-side secure deduplication library operates in conjunction with a secure deduplication layer or server component 173 of a deduplication filesystem that resides at the data protection appliance. These two components perform encryption operations to secure data and decryption operations to facilitate deduplication. Further discussion is provided below.

The disaster recovery site provides protection against regional disasters that may befall the production site. Thus, the disaster recovery site may be established in a geographic location different from a geographic location of the production site. For example, the production site may be located in San Francisco, California, while the disaster recovery site may be located in Philadelphia, Pennsylvania. Client data backed up to the production data protection appliance may thus be replicated periodically or in real-time to the disaster recovery data protection appliance.

In an embodiment, each data protection appliance includes a filesystem 176. The filesystem provides a way to organize data stored in a storage system and present that data to clients and applications in a logical format. The filesystem organizes the data into files and folders into which the files may be stored. When a client requests access to a file, the filesystem issues a file handle or other identifier for the file to the client. The client can use the file handle or other identifier in subsequent operations involving the file. The namespace of the filesystem provides a hierarchical organizational structure for identifying filesystem objects through a file path. A file can be identified by its path through a structure of folders and subfolders in the filesystem. A filesystem may hold many hundreds of thousands or even many millions of files across many different folders and subfolders and spanning thousands of terabytes.

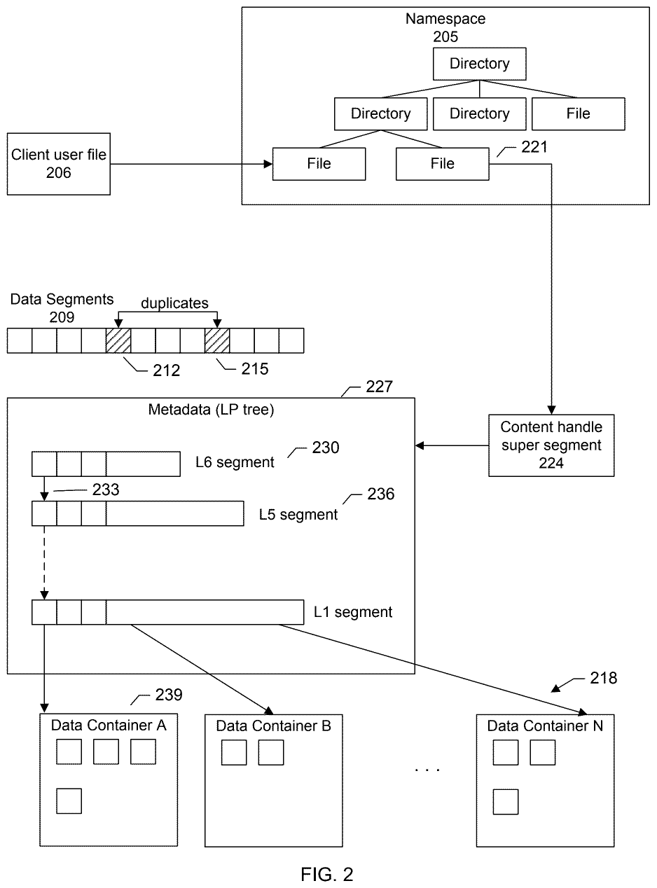

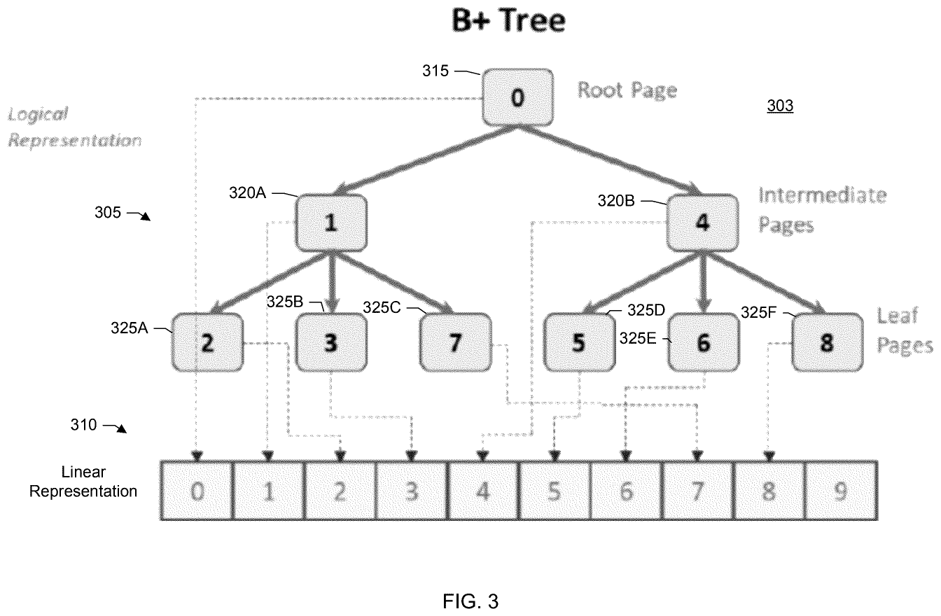

In an embodiment, the filesystem is a deduplicated or deduplication filesystem. FIG. 2 shows a block diagram illustrating a deduplication process of the filesystem according to one or more embodiments. A deduplicated filesystem is a type of filesystem that can reduce the amount of redundant data that is stored. As shown in the example of FIG. 2, the filesystem maintains a namespace 205. Further details of a filesystem namespace are provided in FIG. 3 and the discussion accompanying FIG. 3.

As data, such as incoming client user file 206, enters the filesystem, it is segmented into data chunks or segments 209 and filtered against existing segments to remove duplicates (e.g., duplicate segments 212, 215). The processing of an incoming file may be referred to as ingestion. A segment that happens to be the same as another segment that is already stored in the filesystem may not be again stored. This helps to eliminate redundant data and conserve storage space. Metadata, however, is generated and stored that allows the filesystem to reconstruct or reassemble the file using the already or previously stored segment. Metadata is different from user data. Metadata may be used to track in the filesystem the location of the user data within a shared storage pool. The amount of metadata may range from about 2 or 4 percent the size of the user data.

More specifically, the filesystem maintains among other metadata structures, such as the namespace and inodes, a fingerprint index. The fingerprint index includes a listing of fingerprints corresponding to data segments already stored to the storage pool. A cryptographic hash function (e.g., Secure Hash Algorithm 1 (SHA1)) is applied to segments of the incoming file to calculate the fingerprints (e.g., SHA1 hash values) for each of the data segments making up the incoming file. The fingerprints are compared to the existing fingerprints in the fingerprint index. Matching fingerprints indicate that corresponding data segments are already stored. Non-matching fingerprints indicate that the corresponding data segments are unique and should be stored.

Unique data segments are packed and stored in fixed size immutable containers 218. There can be many millions of containers tracked by the filesystem. The fingerprint index is updated with the fingerprints corresponding to the newly stored data segments. A content handle 221 of the file is kept in the filesystem's namespace to support the directory hierarchy. The content handle points to a super segment 224 which holds a reference to a top of a segment tree 227 of the file. The super segment points to a top reference 230 that points 233 to metadata 236 and data segments 239.

Thus, in an embodiment, each file in the filesystem is represented by a tree. In a specific embodiment, the tree is a Merkle tree. The tree includes a set of segment levels arranged into a hierarchy (e.g., parent-child). Each upper level of the tree includes one or more pointers or references to a lower level of the tree. A last upper level of the tree points to the actual data segments. Thus, upper level segments store metadata while the lowest level segments are the actual data segments. In an embodiment, a segment in an upper level includes a fingerprint (e.g., metadata) of fingerprints of one or more segments in a next lower level (e.g., child level) that the upper level segment references.

An example of a segment tree is shown in FIG. 3. A tree may have any number of levels. The number of levels may depend on factors such as the expected size of files that are to be stored, desired deduplication ratio, available resources, overhead, and so forth. In a specific embodiment, there are seven levels L6 to L0. L6 refers to the top level. L6 may be referred to as a root level. L0 refers to the lowest level. Thus, the upper segment levels (from L6 to L1) are the metadata segments and may be referred to as LPs. That is, the L6 to L1 segments include metadata of their respective child segments. The lowest level segments are the data segments and may be referred to as L0s or leaf nodes. In an embodiment, segments in the filesystem are identified by 24 byte keys (or the fingerprint of a segment), including the LP segments. Each LP segment contains references to lower level LP segments.

FIG. 3 shows further detail of a namespace of the filesystem. In an embodiment, the namespace is represented by a B+ tree data structure where pages of the tree are written to a key-value store. Page identifiers form the keys of the key-value store and page content form the values of the key-value store. The tree data structure includes the folder and file structure as well as file inodes. FIG. 3 shows an example of a B+ Tree 303 in a logical representation 305 and a linear representation 310. In this example, there is a root page 315, intermediate pages 320A, B, and leaf pages 325A-F. The broken lines shown in FIG. 3 map the pages from their logical representation in the tree to their representation as a linear sequential set of pages on disk, e.g., flattened on-disk layout. In other words, the tree may be represented as a line of pages of data.

The intermediate pages store lookup keys that reference other intermediate or leaf pages. An intermediate page may be referred to as an INT page and references other INT pages or leaf pages by interior keys.

The leaf page contains “key/value” pairs. In an embodiment, a B+ Tree key is a 128-bit number kept in sorted order on the page. It is accompanied by a “value,” which is an index to data associated with that key and may be referred to as a “payload.” In an embodiment, the 128-bit key includes a 64-bit PID, or parent file ID (the ID of the directory that owns this item), and a 64-bit CID, or child file ID. In an embodiment, the leaf page stores a key for each file in the filesystem. The key references a payload identifying an inode number of the file and thus a pointer to content or data of the file, such as a set of blocks to read. There can be another key for each file that identifies a name of the file.

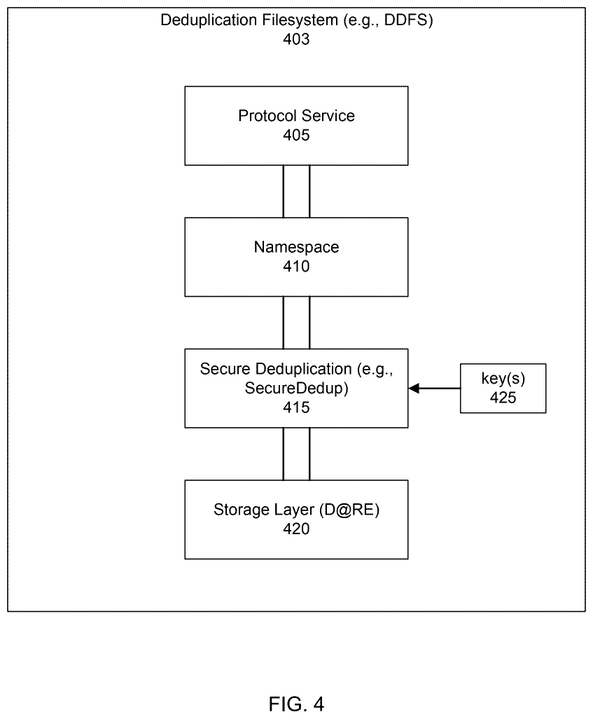

FIG. 4 shows a simplified layer or stack diagram for handling client access requests received by the filesystem at the data protection appliance. Examples of a filesystem and data protection appliance include the Data Domain Filesystem (DDFS) and Data Domain as provided by Dell Technologies. Some embodiments are described in conjunction with the DDBoost protocol, PowerProtect Backup Appliance, and Data Domain Filesystem as provided by Dell Technologies. It should be appreciated, however, that principles and aspects discussed can be applied to other filesystems, filesystem protocols, and backup storage systems.

As shown in the example of FIG. 4, in an embodiment, layers of a filesystem 403 include a protocol service layer 405, namespace layer 410, secure deduplication layer 415, and underlying storage layer 420. The protocol service layer resides at a top of the stack while the storage layer resides at a bottom of the stack. The namespace and secure deduplication layers are between the protocol services layer and storage layer. The namespace layer is between the protocol service layer and secure deduplication layers. The secure deduplication layer is between the namespace and storage layers. In other words, the protocol service layer is followed by the namespace layer. The namespace layer is followed by the secure deduplication layer. The secure deduplication layer is followed by the storage layer.

Client requests are received at the protocol service layer and are passed down to the namespace layer, to the secure deduplication layer, and then down to the storage system layer. Where the request is to retrieve data, the storage system retrieves the requested data and the data then begins its journey back up the stack and ultimately to the requesting client. Each layer is responsible for a set of processing and packaging operations before handing off to a next layer.

For example, in an embodiment, the protocol service is responsible for handling different protocol semantics and translating requests into file system commands. The namespace layer provides unified logical view of stored data regardless of its physical storage location. The namespace layer abstracts data organization and can organize data into a global namespace. That is, data may be distributed across multiple storage devices, but still appear as a single logical entity to client users and applications.

The secure deduplication layer (or SecureDedup) provides encryption to secure data and decryption to facilitate deduplication, validation, integrity or data corruption checks, packaging, compression, and other operations. The secure deduplication layer at the appliance may be referred to as a secure deduplication server as it provides resources, services, and data to other computers, e.g., clients. In an embodiment, the secure deduplication server layer works with the client-side secure deduplication libraries to handle encryption, decryption, and deduplication operations in connection with backing up files and other data from the clients to the data protection appliance and restoring files from the data protection appliance back to the clients. In an embodiment, the client secure deduplication library, the secure deduplication layer, or both decrypt incoming encrypted data streams so that operations such as validation, packaging, compression, deduplication, or combinations of these can be applied to clear text. Once these operations are complete, the client secure deduplication library, the secure deduplication layer, or both encrypt the resulting data for outgoing data streams to prevent unauthorized access. In an embodiment, decryption operations are accompanied with validation checks to help ensure the integrity of the data.

Specifically, one or more keys 425 may be used to encrypt data to prevent unauthorized parties from access and decrypt the data to facilitate deduplication, validation, packaging, and other operations. A key may be referred to as an encryption key or decryption key. The process of encryption includes applying an encryption algorithm using a key to clear text (e.g., readable data) to produce ciphertext. Ciphertext is unreadable, scrambled data. The process of decryption includes applying a decryption algorithm using the correct decryption key to the ciphertext to convert the ciphertext back into clear text. The decryption key may be the same as or different from the key used to encrypt the data. Any competent encryption algorithm may be used. Some examples of encryption algorithms include Advanced Encryption Standard (AES) or Rivest-Shamir-Adleman (RSA). Encryption may rely on symmetric encryption, public key encryption, or both (e.g., hybrid).

During a backup operation, the client-side secure deduplication library functions as a sender or source of encrypted data and the secure deduplication server layer at the data protection appliance functions as a recipient or destination of the encrypted data. During a restoration operation, the roles are reversed. That is, the secure deduplication server layer at the data protection appliance functions as the sender or source of the encrypted data and the client-side secure deduplication library functions as the recipient or destination of the encrypted data. To ensure that a recipient of encrypted data (e.g., secure deduplication server layer or client-side secure deduplication library) can decrypt the data, one or more embodiments use a secure key exchange. More particularly, one or more embodiments may rely on a pre-shared key or symmetric encryption, public key encryption or asymmetric encryption, key wrapping with asymmetric encryption, an external key management system (EKMS), other secure key exchange technique, or combinations of these.

For example, in an embodiment having a pre-shared key, a key is shared ahead of time through a secure channel. The data is encrypted with that key and each of the secure deduplication server layer and client-side secure deduplication library already has the key stored securely. For example, the key may be hard-coded with each of the client-side secure deduplication library and secure deduplication server layer.

In an embodiment having asymmetric encryption, one of a client-side secure deduplication library or secure deduplication server layer encrypts the data with a public key belonging to another of the client-side secure deduplication library or secure deduplication server layer. The recipient or the other of the client-side secure deduplication library or secure deduplication server layer can then decrypt using their private key.

In an embodiment having key wrapping with asymmetric encryption, one of a client-side secure deduplication library or secure deduplication server layer generates a random symmetric key, encrypts the symmetric key with a public key belonging to another of the client-side secure deduplication library or secure deduplication server layer, and sends the encrypted data and encrypted symmetric key alongside or as metadata to the recipient or the other of the client-side secure deduplication library or secure deduplication server layer. The recipient can then decrypt the symmetric key using their corresponding private key and thus decrypt the actual data content.

In an embodiment having an EKMS, keys are stored in a centralized system. At least one of a client-side secure deduplication library or secure deduplication server layer authenticates themselves with the EKMS to retrieve a key. An EKMS is considered highly secure and requires stringent credentials for access. The key returned by the EKMS to the requesting client-side secure deduplication library or secure deduplication server layer may be used to encrypt data or unencrypt data. Embodiments may use any secure key exchange or a combination of secure key exchange techniques. Further discussion is provided below.

The storage layer represents the physical or virtual storage infrastructure where backup data is ultimately stored. In an embodiment, a layered encryption model is used. Data may be encrypted at the application-level, filesystem-level, block/device level (e.g., data-at-rest-encryption (DARE)), or combinations of these. For example, filesystem-level encryption may be used to encrypt data including files, directories, or other data structures before they are written to storage. The underlying storage system may encrypt data at the block or device level. Thus, an application, library, agent, server layer component, or other process or component residing or running above a storage system may encrypt data before handing or writing the data to the storage system which itself may apply another layer of encryption, e.g., data-at-rest-encryption (DARE). In an embodiment, when, for example, a process requests data from the storage system, the storage system may remove the DARE encryption, but the data still remains in an encrypted format because of the layered encryption. There can be double encryption. Data may be encrypted multiple or two or more times.

In an embodiment, a same or single key may be used at each of the different levels to provide encryption and decryption. For example, each of the primary DARE storage system, protection backup storage system, application, secure deduplication client library, and secure deduplication server layer may use the same universal key for encryption and decryption. Use of a single key helps to reduce complexity. In another embodiment, different levels or components may use different or separate keys to enhance security. For example, the underlying storage system may use a first key and components at the filesystem-level (e.g., secure deduplication library, secure deduplication server layer, or both) may use a second key, different from the first key. Using a layered encryption model can help to retain at least some level of security if a key is compromised and facilitate key management flexibility and granular security.

Referring back now to FIG. 1, this system provides for end-to-end secure data protection workflows with encryption and deduplication for operational, disaster, and cyber recovery solutions. In an embodiment, file and storage systems provide for encryption for data at rest and over the wire for extended durations. Encrypting data at rest protects against missed or stolen disks, while over the wire encryption is useful against man in the middle attack. The protocol access is authenticated, and this guards against the unauthorized access to data.

In some systems, however, a malicious user that obtains access to the system can read off the data from the filesystem in clear text. This class of ransomware attacks is called exfiltration. Employing end to end encryption, e.g., the storage system gets an encrypted stream of data, can be used to address the problem. Thereby, even if the data is read by a rogue actor, it is gibberish.

Deduplication filesystems have an inherent problem with ingesting encrypted data. They achieve high ingest performance by “not writing” the duplicate content. The process of encryption, however, changes the entropy in the data stream and drastically affects the data reduction capabilities of a deduplication filesystem. This has an adverse impact on the ingest performance. High entropy also cascades into inefficient replication, tiering capabilities as well as inefficient use of network infrastructure.

The encrypted data cannot be analyzed by ransomware detection software-so this also impacts cyber resiliency capabilities. These issues ultimately result in lower performance, reduced capabilities, and high cost of ownership to customers.

In an embodiment, systems and techniques are provided to secure data end-to-end against data exfiltration attacks. These methods protect all data protection workflows including backups, restores, replication, and cyber recovery. The systems and techniques disclosed retain the benefits of high data reduction with deduplication. Systems and techniques are provided for backup, restore, replication, and cyber recovery protections. Data lands encrypted across the different components of the filesystem and is deduplicated.

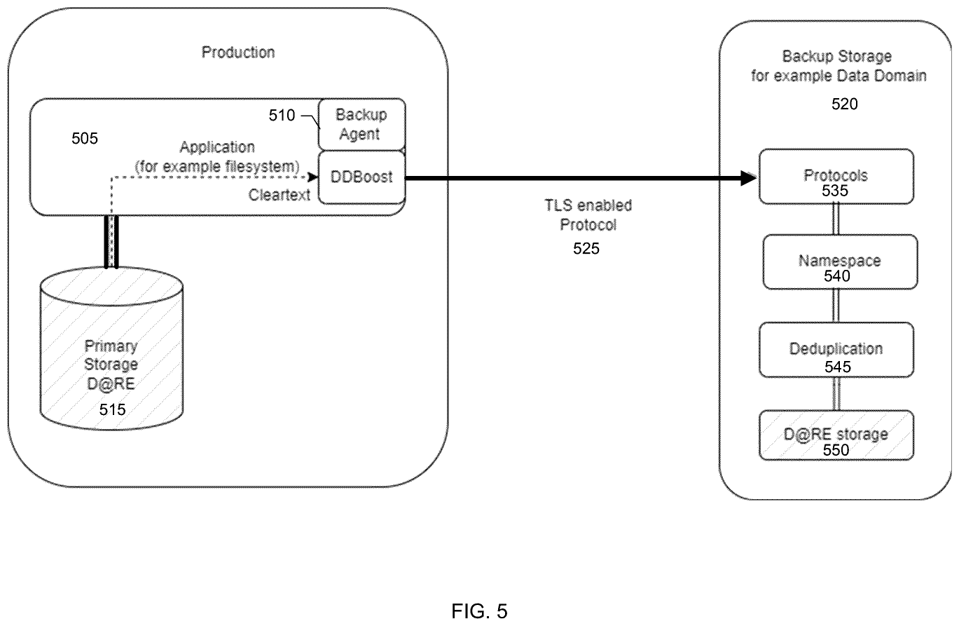

FIG. 5 shows a block diagram of an agent-based backup, according to one or more embodiments. In the example shown in FIG. 5, an application 505 (as an example, a filesystem) is linked with a backup agent 510. The backup agent is part of the trusted domain, and may run as a process within the same compute environment. Primary storage 515 is encrypted (using the data at rest encryption (D@RE)). D@RE is for protection against stolen disks and the like. In FIG. 5 and other figures, encrypted data and communication links are shown using a pattern of diagonal lines or heavily bolded lines.

In an embodiment, the application knows how to decrypt the data when it is read off the disks and has access to clear text data. The backup agent process also accesses clear text data. This data is sent to a backup storage 520 (for example to Power Protect Data Domain (PPDD)). Over the wire encryption 525 protects against over the wire sniffers. Once the data lands in the protection storage, the data is written to protection storage disks 530, which have D@RE encryption.

In the example shown in FIG. 5, the backup storage system includes a protocol layer 535, which translates the protocol semantics, and a namespace layer 540 which uses filesystem semantics. On deduplication storage environments, a deduplication engine 545 performs the data reduction, by deduplicating against the segments written within the filesystem. The deduplicated content (new data) is then written to encrypted storage 550.

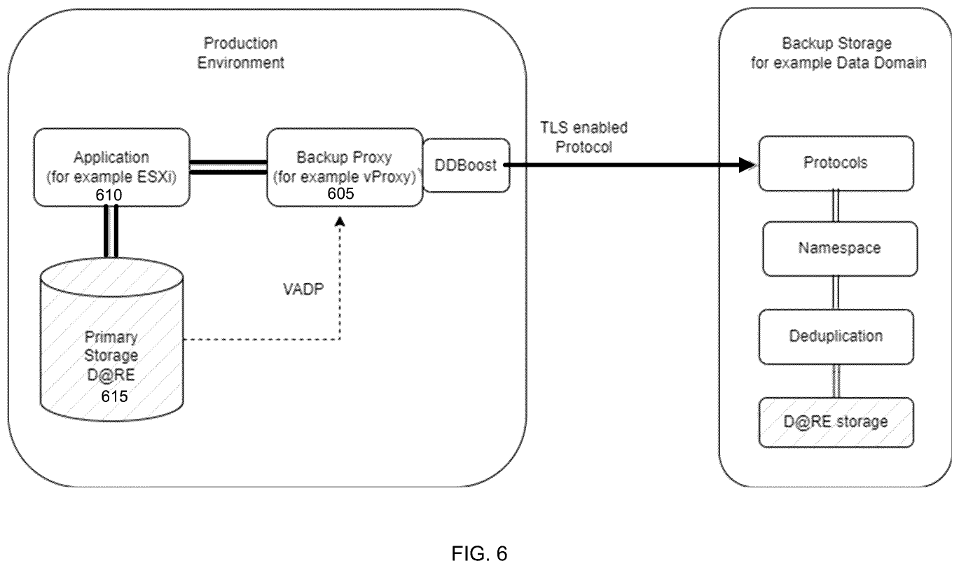

FIG. 6 shows a block diagram of a proxy-based backup, according to one or more embodiments. Proxy-based backups are like agent-based backups, except that the backup process runs in a proxy 605 which is outside the compute domain of the application. For example, vProxy as provided by Dell is a backup proxy process with VMware's ESXi, which communicates with ESXi 610 to access the VM images which must be backed-up. The proxy (the vProxy process) calls a VM ware Application Program Interface (API) for Data Protection (VADP) to obtain the relevant data blocks from primary storage 615. Since the proxy process is part of the trusted domain, it has access to the data that must be protected. The storage is protected using D@RE, and the network accesses are protected using Transport Layer Security (TLS) enabled protocols.

In an embodiment, as the data stream lands in the deduplication filesystem, the filesystem looks for patterns where in a piece of data can be chunked. This process is called anchoring. The pattern is a set of bits. If the incoming data stream has the same set of bits, the filesystem creates a chunk (a variable sized set of data). The filesystem may keep the chunk sizes to be between 4 KB and 12 KB.

Searching for a pattern to anchor, to have variable sized segments, facilitates handling scenarios where data has shifted. The fixed anchors will look like a completely new data stream, if the data shifts.

The data chunk is then hashed using a modified SHA1 algorithm. The hash (also called a fingerprint) is then looked up in a hash table called the index. If the index has a reference to the fingerprint, then the data exists on the system. In such a case, the said chunk does not need to be written to disk, effectively resulting in a data reduction.

The filesystem keeps track of segments which are stored on the disk, and if the segments were to be seen again, the filesystem would just store the reference to the original data segment which was written to disk.

A file is, therefore, a stream of segments. To read a portion of a file, given a file offset and length, the corresponding data segment fingerprints are looked up.

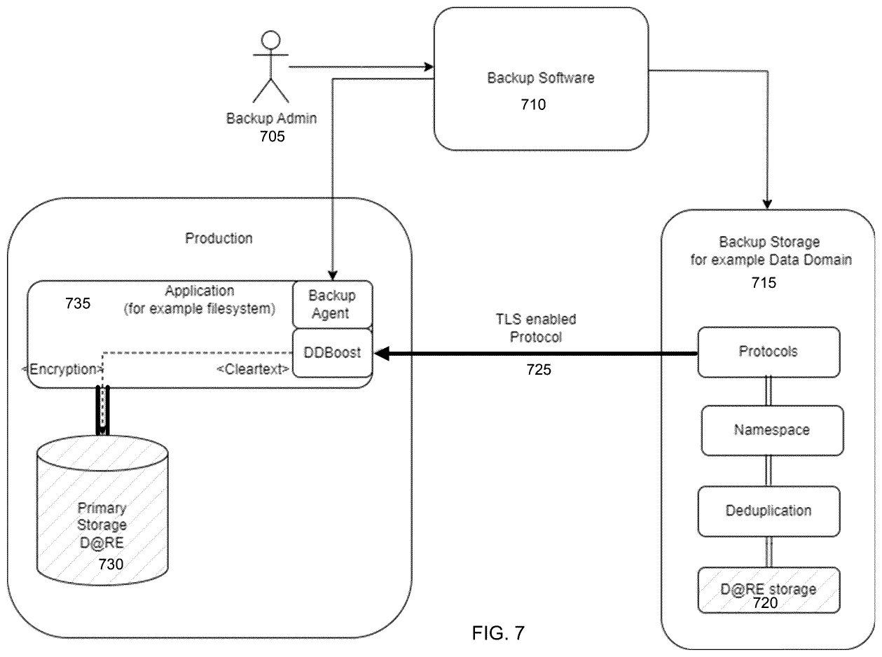

FIG. 7 shows a block diagram of a restoration of a backup, according to one or more embodiments. The restore of backup is similar to an inverse of the backup process. In an embodiment, a backup administrator 705 identifies the backup to be restored through a backup catalog maintained by a backup application 710. The backup catalog lists the saved backup files. The files are then read from backup storage 715. The storage system (disks) is D@RE encrypted 720. Every byte of the file(s) to be restored are read and transmitted over a wire 725. The secured environments have over the wire encryption enabled, and once the data lands on primary storage environment (at a path selected by the backup administrator) 730, the said data is read by an application 735.

In an embodiment, the backup restore operation requires authentication before the reads of the backup files are allowed. The TLS protects against the wire sniffers. FIG. 7 shows an example of the data being read off the backup storage (e.g., DDFS) using the DDBoost protocol. The data is then written to the primary storage by the application process which could encrypt the clear text data delivered by the DDBoost API. Some embodiments are described in conjunction with the DDBoost protocol. It should be appreciated, however, that the described systems and techniques providing secure deduplication is not limited to DDBoost. Public protocols like CIFS or NFS can also take advantage of secure deduplication.

In some cases, if the application host or the storage credentials for the backup storage are compromised, an attacker can access and read the backup files in plain text. This kind of attack vector is called data exfiltration. Employing end-to-end encryption by sending encrypted data to the backup storage can be used to thwart such attacks.

The encryption process, by definition, increases the entropy of the data being encrypted, where in even a small change can lead to a completely new data stream. As discussed, in an embodiment, data deduplication searches for patterns to anchor. With the new data stream, the deduplication process is ineffective. In some cases, this can result in a choice between data security or data reduction. It is desirable to provide both data security and data reduction.

The system shown in FIG. 1 achieves high data reduction by using deduplication while making sure that the data is secure end-to-end. Deduplication filesystems are bandwidth optimized, when it comes to replication (e.g., they deduplicate over the network). There are challenges with deduplication and security as encrypted data does not deduplicate, because of the increased entropy. Further, malware/ransomware scanning software may rely on reading and consuming unencrypted or decrypted data to detect ransomware. If the data read from the protection storage is encrypted, the ransomware scanner software may not be able to detect the anomalies.

As discussed, FIG. 4 shows layers within a deduplication filesystem, according to one or more embodiments. In an embodiment, the protocol service translates the protocol requests to file system commands. The protocol stack may support multiple or several network protocols, and may include protocol servers like NFS, CIFS, DDBoost amongst others. The protocol layer understands transport level security (TLS).

Namespace is the next layer in the filesystem stack. Namespace hosts the metadata about files (like size, create and modify time, and so forth), and their relationships to each other (like which directory they are in, and what relative path).

The secure deduplication layer includes a deduplication engine which anchors, segments, and packs the data in containers. This is the third layer in the stack.

After deduplication, the new data is packed into containers and written to disk, in the last layer, which is aptly called the storage layer. The containers may be encrypted before they are written to disks that are themselves encrypted. This security method may be referred to as “Data at Rest Encryption” (D@RE). This process prevents data leak if the disks were to be stolen.

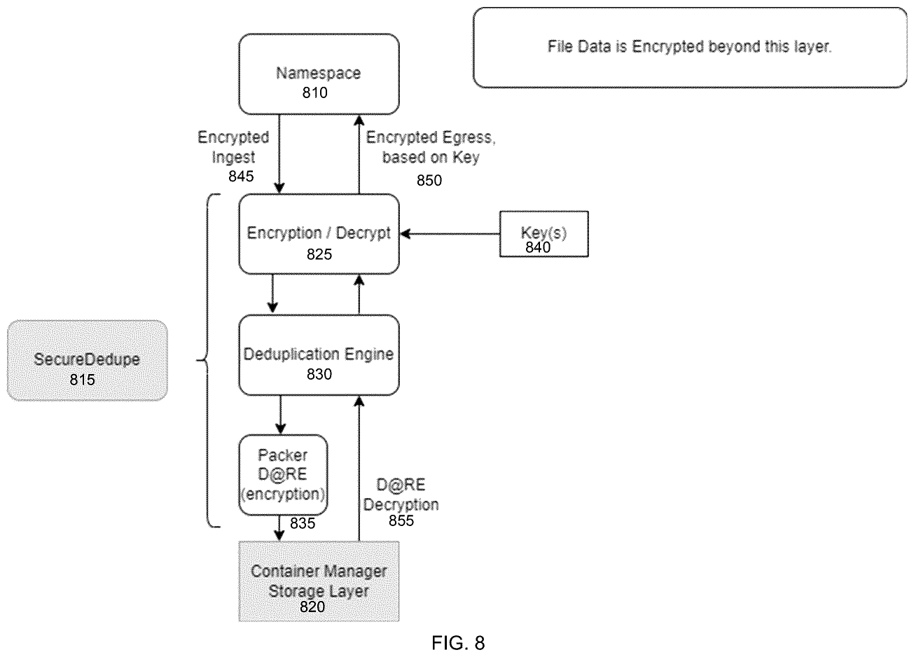

FIG. 8 shows a more detailed block diagram of the filesystem stack layers including the secure deduplication layer shown in FIG. 4. As shown in the example of FIG. 8, there is a namespace layer 810, secure deduplication layer 815 below the namespace layer, and container manager storage layer 820 below the secure deduplication layer. The secure deduplication layer includes a set of sublayers or submodules including an encryption/decryption module 825, followed by a deduplication engine 830, followed by a data packer unit 835. That is, the deduplication engine is positioned between the encryption/decryption module and data packer. The packer is responsible for writing to the container manager and storage layer. The encryption/decryption module accepts one or more keys 840 to conduct encryption and decryption operations. The one or more keys can be provided or managed by the customer rather than a vendor of the data protection appliance.

As shown in the example of FIG. 8, the namespace subsystem calls into the deduplication engine through the encrypt/decrypt module. On an ingress path 845, the encrypt/decrypt module decrypts the data buffers for the ingest path. The decrypted clear-text buffers are passed to the deduplication engine. The deduplication engine works or operates with clear text to achieve the data reduction efficiency.

On an egress path 850, the container manager storage layer may remove DARE encryption 855 from data responsive to the read request. As data proceeds up the stack, the data is encrypted by the encryption/decryption module before being handed to the namespace layer. Thus, data read out of the namespace layer by the protocols layer is encrypted. Specifically, the data buffers are encrypted with a key expected by the client requesting the data. In an embodiment, this is the same key which is used to decrypt the data at the ingest time.

The secure deduplication layer decrypts the data, as it is ingested from the application. The decrypted clear text data is transferred to the deduplication engine (part of the secure deduplication layer). In an embodiment, the secure deduplication layer encrypts any egress traffic using the key the data was ingested with (as it were to be expected by the application). Further discussion is provided below.

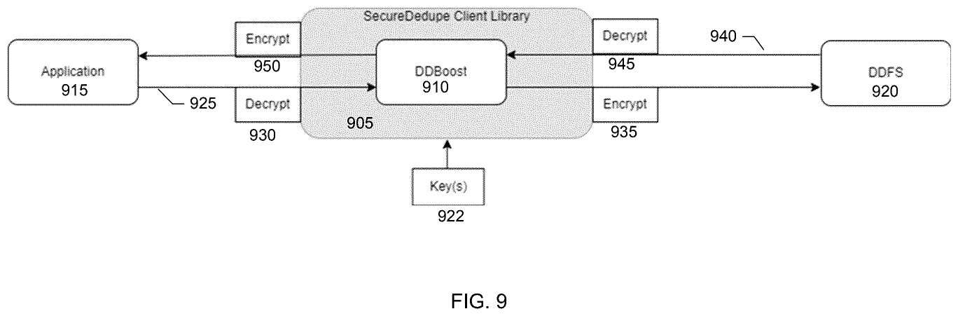

FIG. 9 shows a block diagram of a secure deduplication client library 905, according to one or more embodiments. As discussed, in an embodiment, the secure deduplication client library leverages a library 910 referred to as DDBoost that provides for client-side deduplication, and bandwidth optimization. In an embodiment, the secure deduplication client library is wrapped around the DDBoost client library. The secure deduplication client library handles decryption of an encrypted data stream to the DDBoost client library and encryption of a decrypted data stream from the DDBoost client library.

The DDBoost client library exposes application programming interfaces (APIs) to integrate with the storage system. These API interfaces exported by the DDBoost library provide mechanisms to access or manipulate the functionality of the Data Domain Filesystem (DDFS), as provided by Dell Technologies. Embodiments may utilize the DDBoost Filesystem Plug-In (BoostFS), which resides on the client application system and presents a standard filesystem mount point to the application. With direct access to a BoostFS mount point, the application can leverage the storage and network efficiencies of the DDBoost protocol for backup and recovery. The DDBoost library is optional and may not be included in other embodiments. The secure deduplication library can operate with other client-side agents or libraries to decrypt and encrypt data.

As shown in the example of FIG. 9, the secure deduplication client library is positioned on a data path between a client application 915 and deduplication filesystem 920 (e.g., DDFS). The secure deduplication client library accepts or retrieves one or more keys 922 to conduct encryption and decryption operations on incoming and outgoing data streams.

More particularly, in an embodiment, an ingest path 925 is from the application to the secure deduplication client library with the DDBoost library to the deduplication filesystem. In an embodiment, encrypted data is read into the secure deduplication client library and is decrypted 930 to clear text data before transferring to the DDBoost library. Deduplication can then be performed using the clear text data. The clear text data output from the DDBoost library is converted to an encrypted data stream 935 by the secure deduplication client library.

As an example, consider a backup of a file residing in an encrypted format in production primary DARE storage. The secure deduplication client library may read the file in its encrypted format and decrypt the file for the DDBoost library. The DDBoost library can split the now decrypted file into segments or chunks. Fingerprints or hashes may be computed for each segment. A listing of the fingerprints may be transmitted to the data protection appliance for the deduplication filesystem to check which segments corresponding to the fingerprints are already present or existing in storage at the appliance and which segments corresponding to the fingerprints are new, e.g., not present or missing at the appliance. The deduplication filesystem can respond with indications of the fingerprints corresponding to the new segments. The DDBoost library can select these new segments and pass them to the secure deduplication client library. Segments that the deduplication filesystem has indicated that it already possesses do not have to be again sent. The secure deduplication client library can encrypt the new segments before sending, transmitting, or writing to the data protection appliance.

An egress or read path 940 is from the deduplication filesystem to the secure deduplication client library with the DDBoost library to the application. On the read path, the encrypted stream from the deduplication filesystem is decrypted 945 and handed over to the DDBoost library. As the data is handed over to the application it is encrypted 950 by the secure deduplication client library. Thus, if there were a bad actor which tries to read the data off the secure deduplication enabled system, it would get encrypted data, thus thwarting a data exfiltration attack.

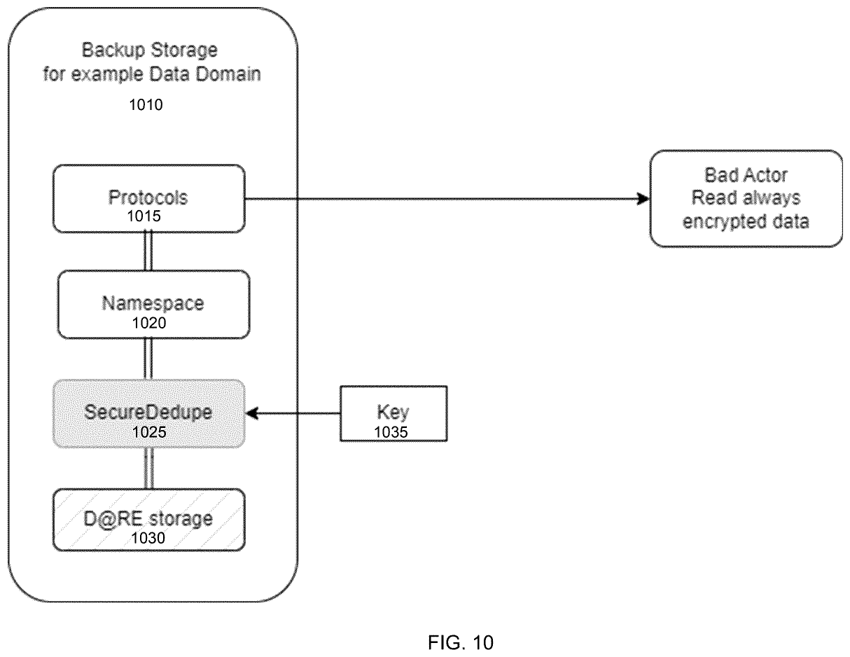

As another example, FIG. 10 shows a block diagram of filesystem layers at a data protection backup storage appliance 1010. As discussed, the filesystem layers include protocols 1015, namespace 1020, secure deduplication 1025, and underlying storage 1030 that uses data at rest encryption. The secure deduplication layer accepts or obtains one or more keys 1035 to conduct encryption and decryption operations. Ingest data streams from the client and received by the protocol, namespace, and secure deduplication layers are encrypted. The secure deduplication layer further encrypts outgoing data streams for writes to the underlying storage. On reads, the secure deduplication layer encrypts the data before handing off to the namespace layer.

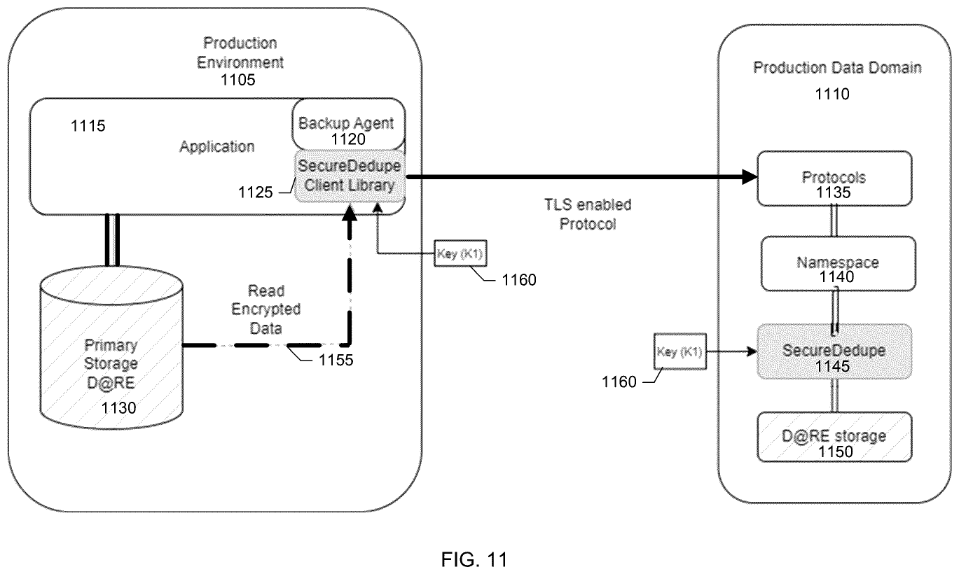

FIG. 11 shows a block diagram of secure deduplication operations on an ingest for backup workloads, according to one or more embodiments. As shown in the example of FIG. 11, there is a production environment 1105 and a production data protection or backup system 1110 (e.g., Data Domain). The production environment includes an application 1115, backup agent 1120, secure deduplication client library 1125, and primary storage 1130 having data-at-rest-encryption (DARE) storage. The production data protection or backup system includes a deduplication filesystem with a protocols layer 1135, followed by a namespace layer 1140, followed by a secure deduplication layer 1145, followed by protection backup storage 1150 having data-at-rest-encryption.

Table A below shows a flow for FIG. 11. Some specific flows are presented in this application, but it should be understood that the process is not limited to the specific flows and steps presented. For example, a flow may have additional steps (not necessarily described in this application), different steps which replace some of the steps presented, fewer steps or a subset of the steps presented, or steps in a different order than presented, or any combination of these. Further, the steps in other embodiments may not be exactly the same as the steps presented and may be modified or altered as appropriate for a particular process, application or based on the data.

TABLE A

| Step | Description |
|---|---|
| 1 | The backup is triggered. The data is read off the primary storage. The secure |
| | deduplication client library may read encrypted data (1155) directly off the primary |
| | storage. |
| 2 | The encrypted data is decrypted by the secure deduplication client library using a key |
| | 1160, and then as part of DDBoost processing, the data is anchored, segmented and |
| | fingerprinted. The fingerprints are then filtered against the production deduplication |
| | filesystem (e.g., Production Data Domain (DDFS)). |
| 3 | The filtered “new” data is encrypted by the secure deduplication client library using the |
| | key, and then sent over the wire to the production data protection backup appliance. The |
| | encrypted data buffers are decrypted, packed into storage containers and then written to |
| | the D@RE enabled storage. |

In an embodiment the key used by the D@RE storage on the production system (K1) is the same as the key (K1) used by the secure deduplication client library and secure deduplication component at the server, and the D@RE storage on the protection backup storage. In another embodiment, at least some of the keys may be different. For example, there can be first, second and third keys. The first key may be different from the second and third keys. The second key may be different from the third key. The first key may be responsible for primary storage D@RE. The second key may be used for writing to the deduplication file system (e.g., Data Domain). The second key may be used at the file system-level to encrypt data before it is written to storage. The third key may be used to maintain the data written to protection backup storage in an encrypted format (e.g., D@RE encryption). Thus, there can be multiple layers of encryption, each using separate or different encryption keys.

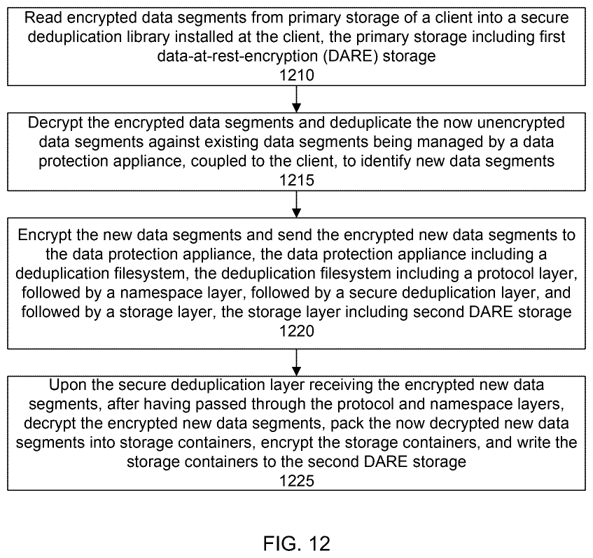

FIG. 12 shows a flow for an ingest of backup workloads, according to one or more embodiments. In a step 1210, encrypted data segments are read from primary storage of a client into a secure deduplication library installed at the client. That is, the data being read into the secure deduplication client library is in an encrypted format. In this embodiment, loading data responsive to the read request from primary storage into memory includes loading data in an encrypted format into the memory. The data is not decrypted into a decrypted format or clear text format before being read into the secure deduplication client library. The primary storage includes first data-at-rest-encryption (DARE) storage.

In a step 1215, the encrypted data segments read into the secure deduplication client library are decrypted and the now decrypted or unencrypted data segments are deduplicated against existing data segments being managed by a data protection or backup appliance, coupled to the client, to identify new data segments.

In a step 1220, the new data segments are encrypted and the encrypted new data segments are sent or transmitted to the data protection appliance. The data protection appliance includes a deduplication filesystem. The deduplication filesystem includes a protocol layer, followed by a namespace layer, followed by a secure deduplication layer, followed by a storage layer. The storage layer includes second DARE storage.

In a step 1225, upon the secure deduplication layer receiving the encrypted new data segments, after having passed through the protocol and namespace layers, the encrypted new data segments are decrypted. The now decrypted new data segments are packed into storage containers and the storage containers are written to the second DARE storage. In an embodiment, the storage containers are encrypted before being written to the second DARE storage.

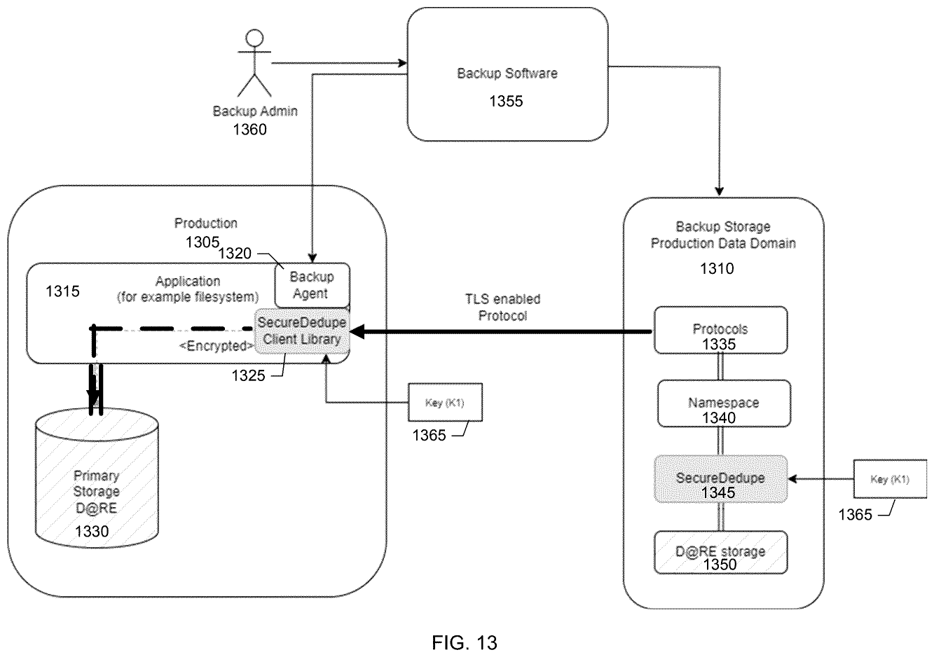

FIG. 13 shows a block diagram of secure deduplication operations for a restoration of a backup, according to one or more embodiments. The system shown in FIG. 13 is similar to the system shown in FIG. 11. As shown in the example of FIG. 13, there is a production environment 1305 and a production data protection or backup system 1310 (e.g., Data Domain). The production environment includes an application 1315, backup agent 1320, secure deduplication client library 1325, and primary storage 1330 having data-at-rest-encryption (DARE) storage. The production data protection or backup system includes a deduplication filesystem with a protocols layer 1335, followed by a namespace layer 1340, followed by a secure deduplication layer 1345, followed by protection backup storage 1350 having data-at-rest-encryption. A backup application 1355 can be accessed by a backup administrator 1360 to initiate the restoration.

Table B below shows a flow for FIG. 13

TABLE B

| Step | Description |
|---|---|
| 1 | While the backups may be automatic, the restore operation for a certain backup, is |
| | typically triggered by a backup administrator. |
| 2 | The backup software or backup application looks up its catalog and identifies the files to |
| | be restored from the protection storage and issues the read input/output (IO) requests to |
| | access the data (held in the said file(s)). This data (read off the production data |
| | protection or backup appliance) is then written to the production primary storage |
| | environment. Once the restore operation completes, the data may be accessed by the |
| | application. |
| 3 | The read IO request is transferred to the secure deduplication layer after validations in |
| | the protocols and namespace layers. On the read IO request, the secure deduplication |
| | layer issues IOs corresponding to the data requested for the file segment. This is read |
| | from the D@RE enabled disks, and the data buffers corresponding to the file segments |
| | are encrypted with a key 1365 by the secure deduplication server as they are handed off |
| | to the namespace layer of the stack. As discussed, in an embodiment, all user data |
| | egressing the secure deduplication layer is encrypted with the said key. |
| 4 | Once the data is received by the secure deduplication client library, it is decrypted, |
| | validated and then encrypted to be written in the production or primary D@RE enabled |
| | storage. |

As discussed, in an embodiment the key used by the primary D@RE storage on the production system is the same as the key used by the secure deduplication client library and secure deduplication at the server, and the D@RE storage on the protection or backup storage. In another embodiment, at least some of the keys are different.

A benefit of the system shown in FIGS. 11 and 13 is that without the access to the said key which is used to encrypt and store the data on the protection or backup storage, any data exfiltration attacks are thwarted, because the read data must be decrypted.

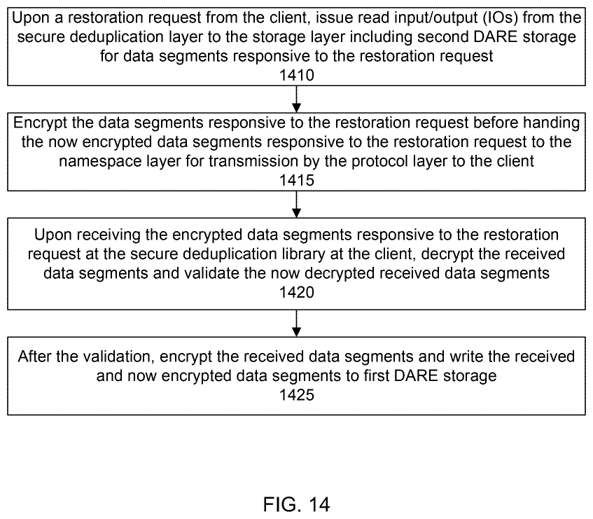

FIG. 14 shows another flow for restoration of a backup, according to one or more embodiments. In a step 1410, upon a restoration request from the client, read IOs are issued from the secure deduplication layer to the storage layer including the second DARE storage for data segments responsive to the restoration request.

In a step 1415, the data segments responsive to the restoration request are encrypted before handing the now encrypted data segments responsive to the restoration request to the namespace layer for transmission by the protocol layer to the client.

In a step 1420, upon receipt of the encrypted data segments responsive to the restoration request at the secure deduplication library at the client, the received data segments are decrypted and the now decrypted received data segments are validated. Validation may include, for example, hash-based integrity checks and comparing checksums and signatures to ensure that data has not been altered in transit, data matches the source, and any corruption or unexpected changes are flagged early.

In a step 1425, after the validation, the received data segments responsive to the restoration are encrypted and written to the first DARE storage of the production or primary storage system.

In an embodiment, a method includes: backing up a client by reading encrypted data segments from a primary storage of the client into a secure deduplication library installed at the client, the primary storage comprising a first data-at-rest-encryption (DARE) storage; decrypting the encrypted data segments with a key and deduplicating the now unencrypted data segments against existing data segments being managed by a data protection appliance, coupled to the client, to identify new data segments; encrypting, with the same key, the new data segments and transmitting the encrypted new data segments to the data protection appliance, the data protection appliance comprising a deduplication filesystem, the deduplication filesystem comprising a protocol layer, followed by a namespace layer, followed by a secure deduplication layer, and followed by a storage layer, the storage layer comprising a second DARE storage; upon the secure deduplication layer receiving the encrypted new data segments, after having passed through the protocol and namespace layers, decrypting the encrypted new data segments with the same key, packing the now decrypted new data segments into storage containers, and writing the storage containers to the second DARE storage; upon a restoration request from the client, issuing read IOs from the secure deduplication layer to the storage layer comprising the second DARE storage for data segments responsive to the restoration; encrypting the data segments responsive to the restoration with the same key before handing the now encrypted data segments responsive to the restoration to the namespace layer for transmission by the protocol layer to the client; upon receiving the encrypted data segments responsive to the restoration at the secure deduplication library at the client, decrypting the received data segments using the same key and validating the now decrypted received data segments; and after the validating, encrypting the received data segments with the same key, and writing the received and now encrypted data segments to the first DARE storage. As discussed, in another embodiment, different keys may be used for the first DARE storage (e.g., primary storage), deduplication filesystem, and second DARE storage (e.g., protection or backup storage).

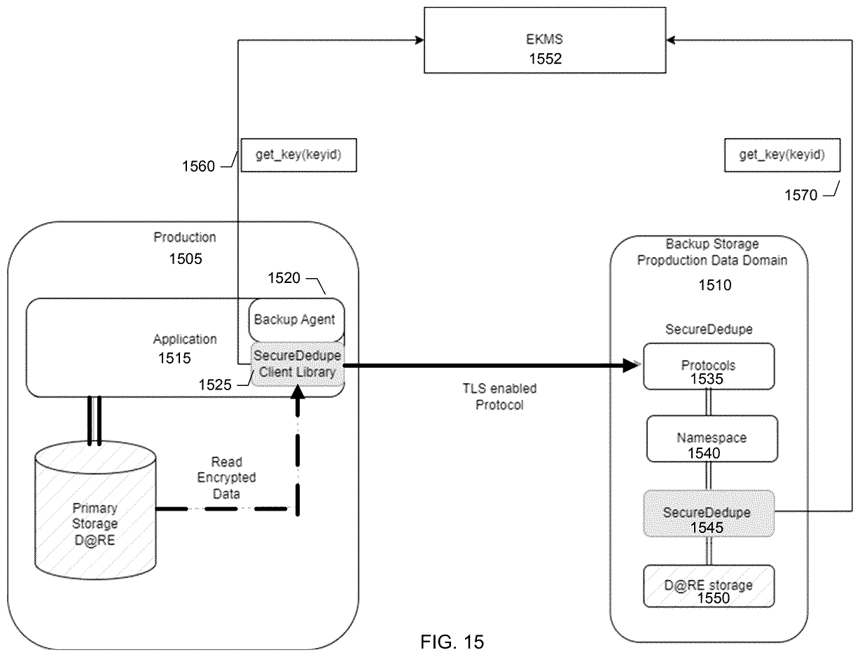

FIG. 15 shows a block diagram of secure deduplication with an external key management system (EKMS). The block diagram shown in FIG. 15 is similar to the block diagram shown in FIG. 11. For example, there is a production environment 1505 and a production data protection or backup system 1510 (e.g., Data Domain). The production environment includes an application 1515, backup agent 1520, secure deduplication client library 1525, and primary storage 1530 having data-at-rest-encryption (DARE) storage. The production data protection or backup system includes a deduplication filesystem with a protocols layer 1535, followed by a namespace layer 1540, followed by a secure deduplication layer 1545, followed by protection backup storage 1550 having data-at-rest-encryption.

An EKMS 1552 is accessible by the secure deduplication client library at the client and secure deduplication server at the data protection appliance. An EKMS is a dedicated system that securely stores, manages, and provides encryption keys to applications, databases, and storage systems. An EKMS may use a key-value store, to organize encryption keys in a database-like structure where each encryption key is associated with a unique identifier (key-value pair).

The EKMS provides enhanced scalability and security. EKMSs are sophisticated appliances which manage cryptographic key generation, distribution and replacement. In an embodiment, the EKMS complies with Key Management Interoperability Protocol (KMIP) standard. The KMIP class of key managers are enterprise grade, compliant with Federal Information Processing Standards (FIPS), and includes rich key management features including Hardware Security Module (HSM) based key generation/storage, large scale key support, key rotation, dynamic cipher configuration, certificate based access, and the like.

In an embodiment, the EKMS is a key-value store which stores cryptographic keys. These can be looked up using a unique key-id. The EKMS are security hardened systems and can be considered invulnerable to the common attack vectors. Given that these key managers are designed for secure access, use of an EKMS can enhance the security posture in a secure deduplication filesystem.

An agent, application, service, or other code component or module can request an encryption key from the EKMS. The EKMS can generate a key and assign it a unique identifier (UUID or hash) that may be referred to as a key identifier (e.g., keyid).

Table C below shows an example of a key-value store that may be maintained by the EKMS.

TABLE C

| Keyid | Encryption Key |
|---|---|
| key_12345 | AE2394DF8C . . . |
| key_67890 | B49C12F7A3 . . . |
| . . . | . . . |

The key-value structure allows for fast lookup and retrieval. When, for example, an application or other process needs to encrypt the data, it issues a request to the EKMS for an encryption key, e.g., “Get the key for ID: key_12345.” The EKMS retrieves the corresponding key from the key-value store. The application uses the key to encrypt data. When decrypting data, the application provides the key ID, e.g., “Decrypt using key_12345.” The EKMS retrieves the corresponding key and returns it only to authorized clients or components. Upon receiving the encryption key, the application can decrypt the data from an encrypted format into an unencrypted or clear text format. The EKMS may enforce key rotation policies (e.g., rotate keys every 90 days). Old keys are marked as inactive but can be kept for decryption.

Table D below shows a flow for FIG. 15.

TABLE D

| Step | Description |
|---|---|
| 1 | The backup is triggered. The data is read off the primary storage. The secure |
| | deduplication client library may read encrypted data (1555) directly off the primary |
| | storage. |
| 2 | The encrypted data is decrypted by the secure deduplication client library using a key |
| | which can be accessed (1560) from the EKMS using a keyid. Then as part of DDBoost |
| | processing, the data is anchored and segmented. The fingerprints are then filtered |
| | against the protection deduplication storage system (e.g., DDFS). |
| 3 | The new data is encrypted by the secure deduplication client library, using another or |
| | different key which is also accessed from the EKMS and then sent over the wire. |
| 4 | The data is decrypted on secure deduplication server using a key looked up (1570) by |
| | the server component, where it decrypted, packed into storage containers and then |
| | written to the D@RE enabled storage. |

Components accessing the EKMS, such as the secure deduplication client library and secure deduplication server component, may maintain or store keyids in a database record, alongside the encrypted data, in configuration files, a metadata block, or any other competent data structure. The keyids may be shared among the different components, such as the secure deduplication client library and secure deduplication server. The sharing allows data sent between the different components to be decrypted.

In an embodiment, the key used by the D@RE storage on the production system may be different from the key used by the secure deduplication client library and secure deduplication component at the server, and the D@RE storage on the protection or backup storage. The EKMS system allows for a multiplicity of these keys. The EKMS systems receives or expects a keyid to lookup the corresponding key, which may be used to encrypt or decrypt the data.

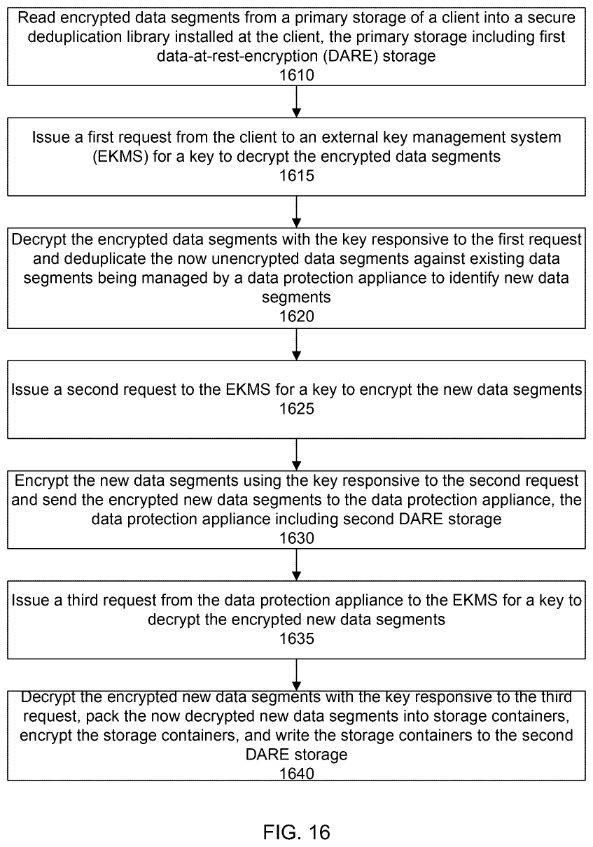

FIG. 16 shows another flow for handling ingest backup workloads with secure deduplication and an EKMS, according to one or more embodiments. In a step 1610, encrypted data segments are read from a primary storage of a client into a secure deduplication library installed at the client, the primary storage including a first data-at-rest-encryption (DARE) storage. In a step 1615, a first request is issued from the client to an external key management system (EKMS) for a key to decrypt the encrypted data segments.

In a step 1620, the encrypted data segments are decrypted with the key responsive to the first request. The now unencrypted data segments are deduplicated against existing data segments being managed by a data protection appliance to identify new data segments not present at the data protection appliance.

In a step 1625, a second request is issued from the client to the EKMS for a key to encrypt the new data segments. In a step 1630, the new data segments are encrypted using the key received from the EKMS and responsive to the second request. The encrypted new data segments are sent from the client to the data protection appliance. The data protection appliance includes a second DARE storage.

In a step 1635, a third request is issued from the data protection appliance to the EKMS for a key to decrypt the encrypted new data segments. In a step 1640, the encrypted new data segments are decrypted with the responsive to the third request. The now decrypted new data segments are packed into storage containers and the storage containers are written to the second DARE storage. The storage containers, prior to being written to the second DARE storage, may be encrypted such as via the key responsive to the third request.

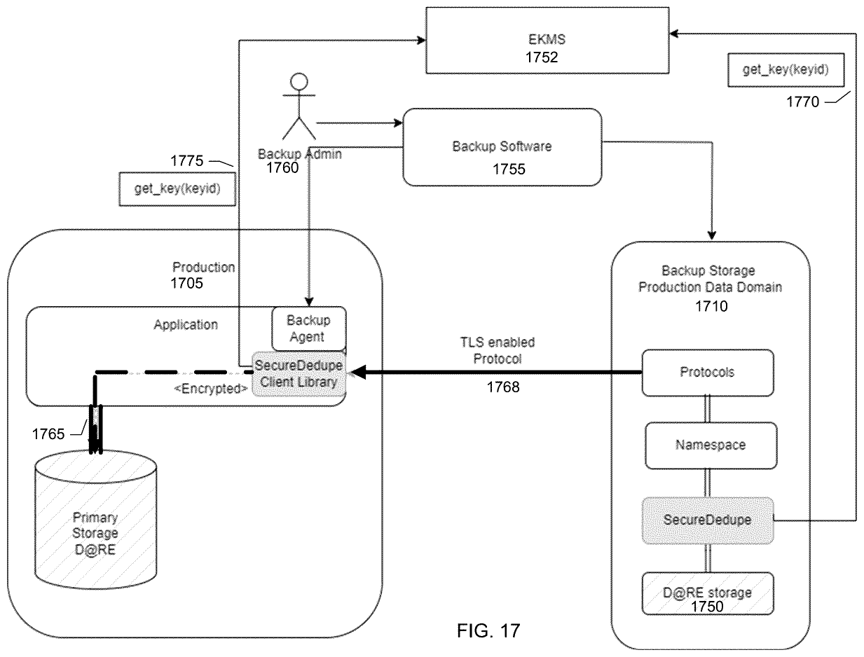

FIG. 17 shows a block diagram of the secure deduplication system handling restorations of backup workloads when paired with an EKMS. The block diagram shown in FIG. 17 is similar to the block diagram shown in FIG. 15. For example, there is a production environment 1705 and a production data protection or backup system 1710 (e.g., Data Domain). The production environment includes an application, backup agent, secure deduplication client library, and primary storage having data-at-rest-encryption (DARE) storage. The production data protection or backup system includes a deduplication filesystem with a protocols layer, followed by a namespace layer, followed by a secure deduplication layer, followed by protection backup storage having data-at-rest-encryption. An EKMS 1752 is accessible by the secure deduplication client library at the client and secure deduplication server at the data protection appliance. A backup application or software 1755 can be accessed by a backup administrator 1760 to initiate the restoration.

Table E below shows a flow for FIG. 17.

TABLE E

| Step | Description |
|---|---|
| 1 | While the backups may be automatic, the restore operation for a certain backup, is |
| | typically triggered by a backup administrator. |
| 2 | The backup software or backup application looks up its catalog and identifies the files to |
| | be restored from the protection storage and issues the read input/output (IO) requests to |
| | access the data (held in the file(s)). This data is then written (1765) to the production |
| | storage environment and is accessed by the application (once the restore operation |
| | completes). |
| 3 | On the read request, the filesystem reads the data from the D@RE enabled disks 1750 |
| | and creates data buffers corresponding to the file segments requested to be read. This |
| | involves decryption of the data segments read from the disks, and then copying the |
| | portion of the data segment which is required to serve the read request to data buffers |
| | which are sent over the wire (1768) |
| 4 | The data buffers are encrypted with the key by the secure deduplication server as they |
| | are handed off to the namespace layer of the stack. This key is looked up from the |
| | EKMS, by a given keyid (1770). |
| 5 | Once the data is received by the secure deduplication client library, it is decrypted using |
| | a key which is looked up (1775) on the EKMS by the secure deduplication client library. |
| | Upon decryption, the data buffers are validated and then encrypted to be written in the |
| | production D@RE enabled storage. The encryption uses the key which is also looked up |
| | by the secure deduplication client library. These keys may be same, or different. |

The key used by the D@RE storage on the production system may be different from the key used by the SecureDedupe client library and SecureDedupe at the server, and the D@RE storage on the protection storage. As discussed, the EKMS system allows for multiplicity of these keys. The EKMS systems expects a keyid to lookup the corresponding key, which may be used to encrypt or decrypt the data. This ability to have a multiplicity of keys enables highly distinctive and valuable capabilities.

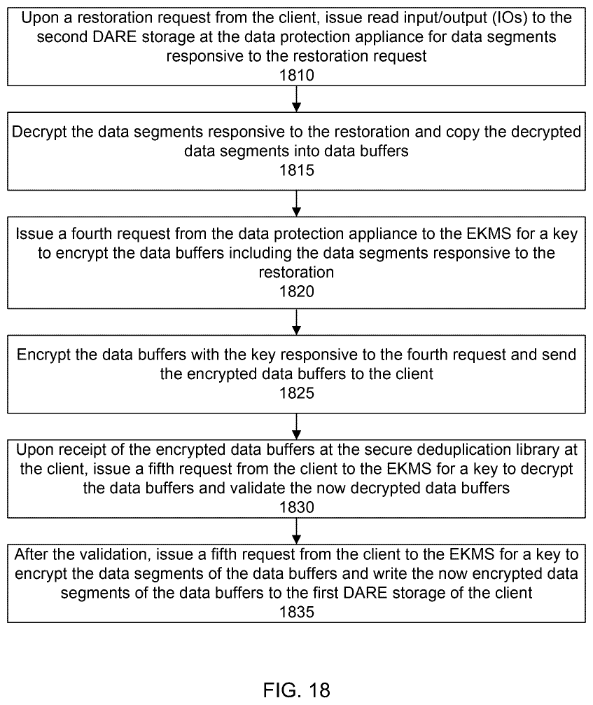

FIG. 18 shows another flow for restoration of a backup using an EKMS, according to one or more embodiments. In a step 1810, upon a restoration request from the client, read IOs are issues to the second DARE storage at the data protection appliance for data segments responsive to the restoration request. In a step 1815, the data segments responsive to the restoration are decrypted and the decrypted data segments are copied into data buffers.

In a step 1820, a fourth request is issued from the data protection appliance to the EKMS for a key to encrypt the data buffers including the data segments responsive to the restoration. In a step 1825, the data buffers are encrypted with the key responsive to the fourth request and the encrypted data buffers are sent to the client.

In a step 1830, upon receipt of the encrypted data buffers at the secure deduplication library at the client, a fifth request is issued from the client to the EKMS for a key to decrypt the data buffers. The now decrypted data buffers are validated.

In a step 1835, after the validation, a fifth request is issued from the client to the EKMS for a key to encrypt the data segments of the data buffers. The now encrypted data segments of the data buffers are written to the first DARE storage of the client.

In an embodiment, a method includes: backing up a client by reading encrypted data segments from a primary storage of the client into a secure deduplication library installed at the client, the primary storage comprising a first data-at-rest-encryption (DARE) storage; issuing a first request from the client to an external key management system (EKMS) for a key to decrypt the encrypted data segments; decrypting the encrypted data segments with the key responsive to the first request and deduplicating the now unencrypted data segments against existing data segments being managed by a data protection appliance to identify new data segments; issuing a second request to the EKMS for a key to encrypt the new data segments; encrypting the new data segments using the key responsive to the second request and sending the encrypted new data segments to the data protection appliance, the data protection appliance comprising a second DARE storage; issuing a third request from the data protection appliance to the EKMS for a key to decrypt the encrypted new data segments; decrypting the encrypted new data segments with the key responsive to the third request, packing the now decrypted new data segments into storage containers, and writing the storage containers to the second DARE storage; upon a restoration request from the client, issuing read IOs to the second DARE storage for data segments responsive to the restoration; decrypting the data segments responsive to the restoration and copying the decrypted data segments into data buffers; issuing a fourth request from the data protection appliance to the EKMS for a key to encrypt the data buffers comprising the data segments responsive to the restoration; encrypting the data buffers with the key responsive to the fourth request and sending the encrypted data buffers to the client; upon receiving the encrypted data buffers at the secure deduplication library at the client, issuing a fifth request from the client to the EKMS for a key to decrypt the data buffers and validating the now decrypted data buffers; and after the validating, issuing a fifth request from the client to the EKMS for a key to encrypt the data segments of the data buffers, and writing the now encrypted data segments of the data buffers to the first DARE storage.

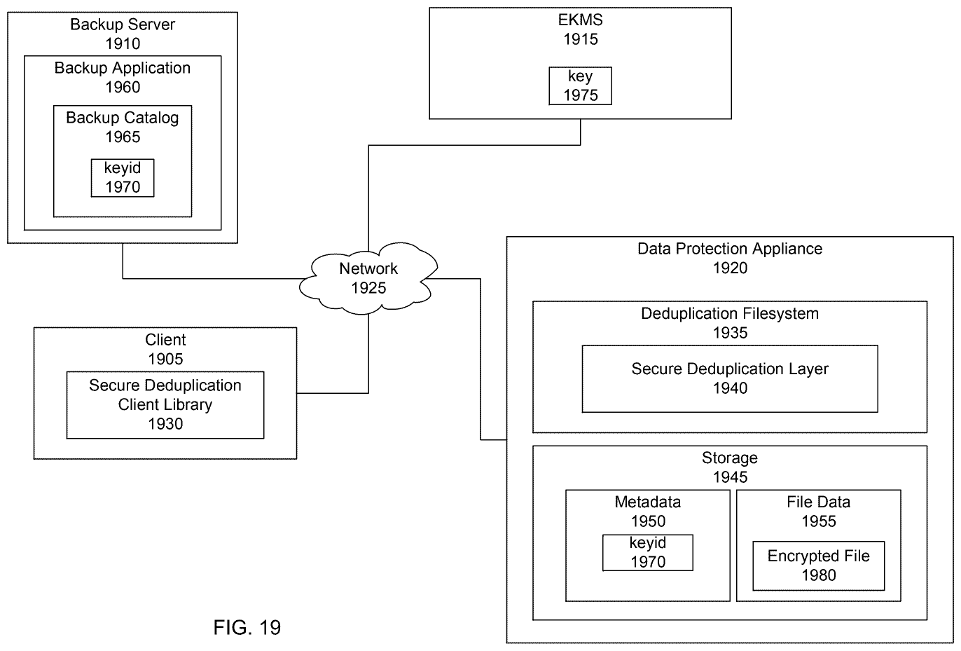

FIG. 19 shows a block diagram for granular encryption, according to one or more embodiments. In an embodiment, the availability of a multiplicity of keys is leveraged to provide encryption at granular levels. In an embodiment, using this ability of using the multiplicity of keys, a system is designed where a key can be used for a limited subset of files. This limited subset may be a set of backups, a namespace, or even a single file. The following is a discussion of per-file encryption, using a different key.

In the example of FIG. 19, there is a client 1905, backup management server 1910, EKMS 1915, data protection appliance 1920, and a network 1925 connecting the components. The client includes a secure deduplication client library 1930. The data protection appliance includes a deduplication filesystem 1935 having a secure deduplication layer or server 1940 and storage 1945. In an embodiment, the storage includes a DARE storage system. The storage includes a metadata region 1950 and a data region 1955, separate from the metadata region. The backup management server includes a backup application 1960 with a backup catalog 1965. In an embodiment, a key identifier (keyid) 1970 to a key 1975, managed by the EKMS, is stored with the backup catalog and as metadata or an extended attribute of the filesystem. The key is used to encrypt (and decrypt) one or more files 1980 managed by the filesystem.

The system shown in the example of FIG. 19, and also FIGS. 15 and 17, allows having a system which stores files which are encrypted with their own key, and yet retain the benefits of data reduction using deduplication. As discussed, the EKMS expects a keyid for each encryption key. In an embodiment, upon the ingest of the file this keyid is stored as an extended attribute of or associated with the file on the protection storage filesystem and with the backup systems catalog. The keyid is an opaque handle to get the key from the EKMS. Access to the keyid and subsequent highly secure access to the EKMS yields the key required to decrypt the stream of data.

In an embodiment, upon restore (on a read IO request), the secure deduplication layer queries the EKMS for the key using the keyid stored as part of the extended metadata of the file, and then encrypts the data buffers.

The keyid (stored with the backup catalog) is then used to query the EKMS for a key to decrypt the encrypted data buffers by the secure deduplication client library.

This technique of granular encryption can be spanned to any granularity. As an example, a single key can be used to encrypt the entire data protection system. An administrator could choose to have one key for each client that is backing up. In an alternative deployment, there may be one key for each asset class (for example VM backups use VM keyid), or there could be a key for each VM backup. The customer may also choose to have a key per protection storage namespace. Thus, encryption can be made granular at file boundaries. When every file has its own key, a corresponding keyid may be stored where a file id can be used to look up the keyid. Using a file extended attribute to store the keyid facilitates lookups of the relationship.

Alternatively, encryption may be at namespace boundaries, where the keyid is stored as an extended attribute for the namespace. The granular encryption keyid for a file set (e.g., a namespace) can be kept as a namespace extended attribute.

This technique of granular key encryption can be used to create a highly secure multi-tenancy environment where the different tenants cannot interpret the data, even if they somehow had access to the namespace.

Consider, as an example, a set of files. Each file may be associated with a keyid stored as an extended attribute associated with the file. The keyid corresponds to an encryption key. For example, a first extended attribute associated with a first file may store a first keyid corresponding to a first key. A second extended attribute associated with a second file may store the same first keyid. Thus, both files may be encrypted (or decrypted) using the same key. The first and second files may belong to the same department (e.g., finance department) and share the same namespace.

Alternatively, the second extended attribute may store a second keyid, different from the first keyid. The second keyid corresponds to a second key, different from the first key. Thus, the first file may be encrypted (or decrypted) using the first key, but not the second key. The second file may be encrypted (or decrypted) using the second key, but not the first key. The first and second files may belong to different departments that do not share namespaces. For example, the first file may belong to the finance department and the second file may belong to the human resources (HR) department. The granularity can be established at any level such as at the level of a file, directory, asset class, file type, backup generation, namespace, department, and so forth. This allows a customer to fine-tune the desired level of security and isolation. The use of granular encryption allows separate data or filesets in the same protection or backup storage system to be managed independently with different keys and policies.

Furthermore, the granular key encryption, and the per file metadata method enables key rotation. Since the keyid is a property of the file, it allows for older backups to be are backed up using old keys and the new backup to use a new (different) key. If a certain key were to be compromised, re-keying those files can be a limited to a subset of the data.

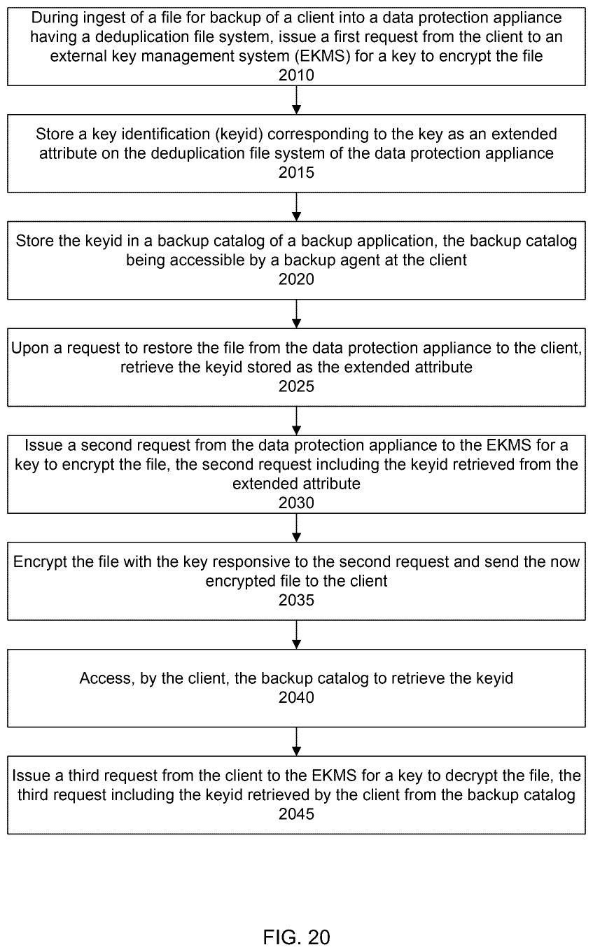

FIG. 20 shows a flow for granular encryption, according to one or more embodiments. In a step 2010, during ingest of a file for backup of a client into a data protection appliance having a deduplication filesystem, a first request is issued from the client to an external key management system (EKMS) for a key to encrypt the file. The file is encrypted using the key responsive to the first request.

In a step 2015, a key identification (keyid) corresponding to the key is stored as an extended attribute on the deduplication filesystem of the data protection appliance.

In a step 2020, the keyid is stored in a backup catalog of a backup application, the backup catalog being accessible by a backup agent at the client.

In a step 2025, upon a request to restore the file from the data protection appliance to the client, the keyid stored as the extended attribute is retrieved.

In a step 2030, a second request is issued from the data protection appliance to the EKMS for a key to encrypt the file, the second request including the keyid retrieved from the extended attribute. In a step 2035, the file is encrypted with the key responsive to the second request. The now encrypted file is sent to the client.

In a step 2040, the client accesses the backup catalog to retrieve the keyid.

In a step 2045, a third request is issued from the client to the EKMS for a key to decrypt the file, the third request including the keyid retrieved by the client from the backup catalog.

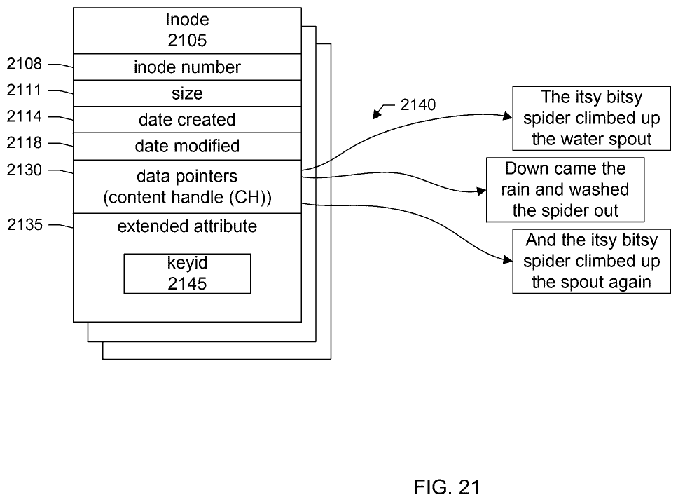

The keyid may be stored as metadata by the filesystem. For example, the keyid may be stored in a metadata store, file, or database, separate from the file content. FIG. 21 shows an example of an inode. An inode is a type of data structure that may be stored by the filesystem. In an embodiment, each file and directory in the filesystem is associated with an inode. The inode stores metadata about a file or directory such as a file type (e.g., file or directory), permissions, timestamps, ownership, pointers to actual data blocks, and so forth. In other words, the inode associated with a file stores metadata about the file.

FIG. 21 shows a block diagram of an inode 2105 that may be associated with a file. The inode includes an inode or file number 2108. The inode number uniquely identifies the inode from among other inodes in the filesystem. Other attributes of the inode may include a size 2111 indicating a size of a file associated with the inode, date created 2114 indicating a time and date the file was created, date modified 2118 indicating a time and date the file was last modified, a set of data pointers 2130, and one or more extended attributes 2135, among other attributes (e.g., file owner, file permissions, and so forth). The data pointers store location information or addresses mapping 2140 the inode to the actual data.

An extended attribute is a metadata property that the filesystem can use to associate with a file or directory beyond the standard attributes (e.g., filename, size, timestamps, permissions). Extended attributes allow additional data to be stored with a file without modifying the file contents. Each file or directory can have multiple extended attributes, stored as key-value pairs. Extended attributes may be stored outside the main file data content region but within the filesystem structure. In an embodiment, a key identification (keyid) 2145 is stored as an extended attribute of an inode.

In an embodiment, a method includes while ingesting a file for backup from a client into a data protection appliance having a deduplication file system, issuing a first request from the client to an external key management system (EKMS) for a key to encrypt the file; storing a key identification (keyid) corresponding to the key as an extended attribute on the deduplication file system of the data protection appliance; storing the keyid in a backup catalog of a backup application, the backup catalog being accessible by a backup agent at the client; upon a request to restore the file from the data protection appliance to the client, retrieving the keyid stored as the extended attribute; issuing a second request from data protection appliance to the EKMS for a key to encrypt the file, the second request comprising the keyid retrieved from the extended attribute; encrypting the file with the key responsive to the second request and sending the now encrypted file to the client; accessing, by the client, the backup catalog to retrieve the keyid; and issuing a third request from the client to the EKMS for a key to decrypt the file, the third request comprising the keyid retrieved by the client from the backup catalog.

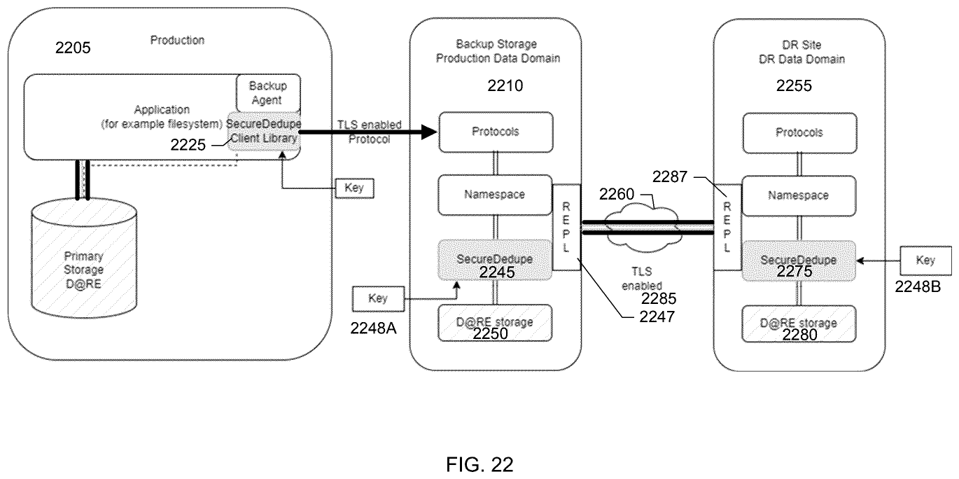

FIG. 22 shows a block diagram of secure deduplication in connection with disaster recovery. The system shown in FIG. 22 is similar to the system shown in FIG. 11. For example, there is a production environment 2205 and a production data protection or backup system 2210 (e.g., Data Domain). The production environment includes an application, backup agent, secure deduplication client library 2225, and primary storage having data-at-rest-encryption (DARE) storage. The production data protection or backup system includes a deduplication filesystem with a protocols layer, followed by a namespace layer, followed by a secure deduplication layer 2245, followed by protection backup storage 2250 having data-at-rest-encryption.

The system shown FIG. 22, however, includes a disaster recovery site that may include a second data protection appliance 2255, connected to (first) data protection appliance 2210, via a network 2260. The second data protection appliance may be similar to the first data protection appliance. For example, the second data protection appliance includes a deduplication filesystem with a protocols layer, followed by a namespace layer, followed by a secure deduplication layer 2275, followed by protection backup storage 2280 having data-at-rest-encryption. In an embodiment, the first and second data protection appliance are configured for replication. Specifically, backups from clients to the first data protection appliance may be replicated to the second data protection appliance. The replicated backups may be referred to as a replica.

More particularly, in an embodiment, the backup process as discussed includes data being read off the production storage and sent to the deduplication aware protection storage. The transfer of the data can be bandwidth optimized using the DDBoost protocol.

Once the data lands on the protection storage it can be sent to the disaster recovery site using one of the two replication techniques. Managed File Replication (MFR) is a technique, where the DDBoost enabled backup application instructs filesystem (e.g., DDFS) to replicate a certain file (from certain namespace (storage unit)) to another namespace on a replication data protection (e.g., DD) system. The replication process is bandwidth optimized, so only the new segments are transferred over.

In another embodiment, replication includes snapshot replication. Snapshot replication may be referred to as M tree Replication. In an embodiment, snapshot replication creates a snapshot on the source namespace, which is the compared against the last transferred snapshot on the replica. The new and modified files are transferred over (using the filtering process).

Regardless of the transfer process, the over the wire traffic secured by TLS 2285, in a secure setting, and the replicated data lands on a D@RE enabled storage.

In an embodiment, if the data written to the primary protection storage is encrypted by the application, the data which is replicated to the disaster recovery protection storage will have little to no data reduction. This is because encryption introduces entropy and the data reduction techniques like deduplication and compression do not work very well with high entropy data. Therefore, the hard choice of storage efficiency (with data deduplication) or security (with end-to-end encryption) extends to the disaster recovery site. This is because data exfiltration attack surface extends to the disaster recovery site as well.

In an embodiment, systems and techniques provide secure deduplication in connection with replication, thereby helping to prevent data exfiltration attacks while also conserving storage space through deduplication. Specifically, table F below shows a flow for FIG. 22 for achieving both replication and deduplication to a disaster recovery site in a secure manner.

TABLE F

| Step | Description |
|---|---|
| 1 | The backup is triggered. The backup process copies the data securely to the protection |
| | storage. Specifically, the data is read off the primary storage. The secure deduplication |
| | client library may read encrypted data directly off the primary storage. |
| 2 | The encrypted data is decrypted by the secure deduplication client library, and then as |
| | part of DDBoost processing, the data is anchored and segmented. The fingerprints are |
| | then filtered against the protection deduplication storage system (e.g., DDFS). |
| 3 | The new data is encrypted by the secure deduplication client library and then sent over |
| | the wire, where it decrypted, packed into storage containers and then written to the |
| | D@RE enabled storage at the backup storage production data protection appliance. |
| 4 | The key used by the D@RE storage on the production system may be the same as the |
| | key used by the secure deduplication client library and secure deduplication server |
| | module or layer at the protection storage, and the D@RE storage on the protection |
| | storage. Alternatively, the keys may be different. For example, a first key (k1) may be |
| | responsible for primary storage D@RE, a second key (k2) may be for writing to the data |
| | protection appliance or filesystem (e.g., Data Domain), and a third key (k3) may be the |
| | filesystem's (e.g., is the Data Domain) D@RE encryption. |
| 5 | Once the data lands on the protection storage, the data is replicated 2287 to the disaster |
| | recovery (DR) site using one of the two techniques. Managed File Replication (MFR) is |
| | DDBoost integrated application directed. The application instructs the primary |
| | protection storage to replicate the given file to the DR site. The other technique is |
| | snapshot replication (Mtree replication). This technique creates a snapshot on the source |
| | namespace, which is the compared against the last transferred snapshot on the replica. |
| | The new and modified files are transferred over (using the filtering process). Regardless |
| | of the replication method, the data transfer is bandwidth optimized, e.g., only the new |
| | data needs to be sent across the wire to the DR site. The new data is encrypted by the |
| | secure deduplication layer (2245) as it is read by a replication module 2247, in the |
| | primary protection storage, using the key 2248A and then sent over the wire 2285 to the |
| | DR protection storage. |
| 6 | Upon receiving the new data buffers, the secure deduplication layer 2275 in the DR |
| | protection storage decrypts the buffers received from the replication protocol using the |
| | key 2248B. These buffers are validated and then written to the DR protection storage |
| | 2280. |

The secure deduplication technique encrypts all data which is being read off the disaster protection storage as well, while enabling the storage efficiency. In an embodiment the key used by the D@RE storage on the production system is the same as the key used by the secure deduplication client library and secure deduplication process at the server, and the D@RE storage on the protection storage (backup storage production). In another embodiment, at least some keys may be different. For example, a first key (k1) may be responsible for primary storage D@RE, a second key (k2) may be for writing to the production data protection appliance or filesystem (e.g., Data Domain), a third key (k3) may be the backup production storage (e.g., is the Data Domain) D@RE encryption, and a fourth key (k4) may be used for the replica at the disaster recovery site.

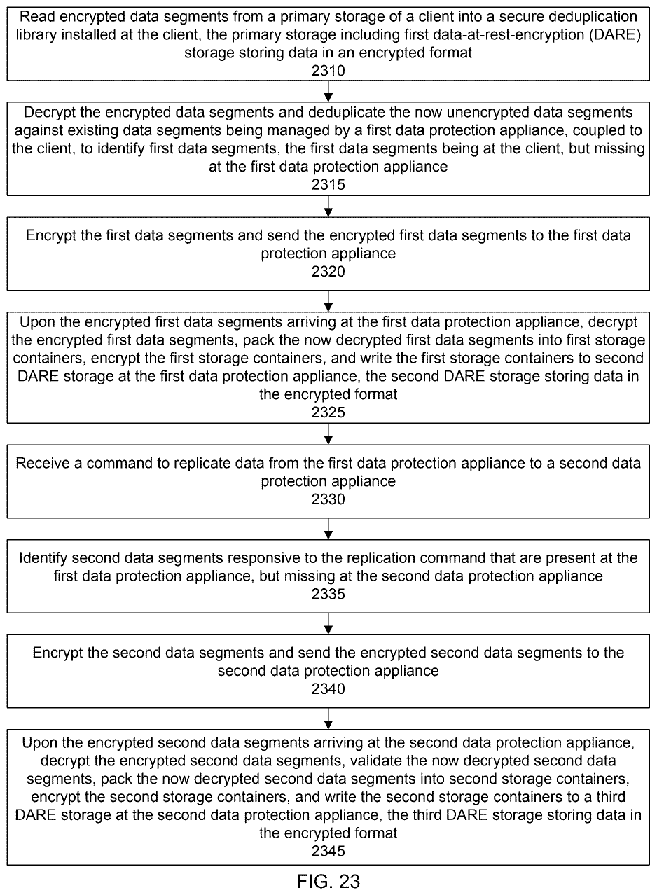

FIG. 23 shows a flow for secure deduplication in connection with replication to a disaster recovery site, according to one or more embodiments. In a step 2310, encrypted data segments are read from a primary storage of a client into a secure deduplication library installed at the client, the primary storage including first DARE storage storing data in an encrypted format. In a step 2315, the encrypted data segments are decrypted. The now unencrypted data segments are deduplicated against existing data segments being managed by a first data protection appliance, connected to the client, to identify first data segments, the first data segments being at the client, but missing at the first data protection appliance.

In a step 2320, the first data segments are encrypted. The encrypted first data segments are sent to the first data protection appliance.

In a step 2325, upon the encrypted first data segments arriving at the first data protection appliance, the encrypted first data segments are decrypted. The now decrypted first data segments are packed into first storage containers. The first storage containers are encrypted and written to second DARE storage at the first data protection appliance.

In a step 2330, a command is received to replicate data from the first data protection appliance to a second data protection appliance. The second data protection appliance may be remote from the first data protection appliance.

In a step 2335, an identification is made of second data segments responsive to the replication command that are present at the first data protection appliance, but missing at the second data protection appliance. In a step 2340, the second data segments are encrypted and the encrypted second data segments are sent to the second data protection appliance.

In a step 2345, upon the encrypted second data segments arriving at the second data protection appliance, the encrypted second data segments are decrypted. The now decrypted second data segments are validated and packed into second storage containers. The second storage containers are encrypted and written to a third DARE storage at the second data protection appliance, the third DARE storage storing data in the encrypted format.

In an embodiment, a method includes: backing up a client by reading encrypted data segments from a primary storage of the client into a secure deduplication library installed at the client, the primary storage comprising a first data-at-rest encryption (DARE) storage storing data in an encrypted format using a key; decrypting the encrypted data segments with the same key and deduplicating the now unencrypted data segments against existing data segments being managed by a first data protection appliance, coupled to the client, to identify first data segments, the first data segments being at the client, but missing at the first data protection appliance; encrypting, with the same key, the first data segments and sending the encrypted first data segments to the first data protection appliance; upon the encrypted first data segments arriving at the first data protection appliance, decrypting the encrypted first data segments with the same key, packing the now decrypted first data segments into first storage containers, and writing the first storage containers to a second DARE storage at the first data protection appliance, the second DARE storage storing data in the encrypted format using the same key; receiving a command to replicate data from the first data protection appliance to a second data protection appliance; identifying second data segments responsive to the replication command that are present at the first data protection appliance, but missing at the second data protection appliance; encrypting the second data segments with the same key and sending the encrypted second data segments to the second data protection appliance; and upon the encrypted second data segments arriving at the second data protection appliance, decrypting the encrypted second data segments with the same key, validating the now decrypted second data segments, packing the now decrypted second data segments into second storage containers, and writing the second storage containers to a third DARE storage of the second data protection appliance, the third DARE storage storing data in the encrypted format using the same key. In another embodiment, at least some of the keys may be different.

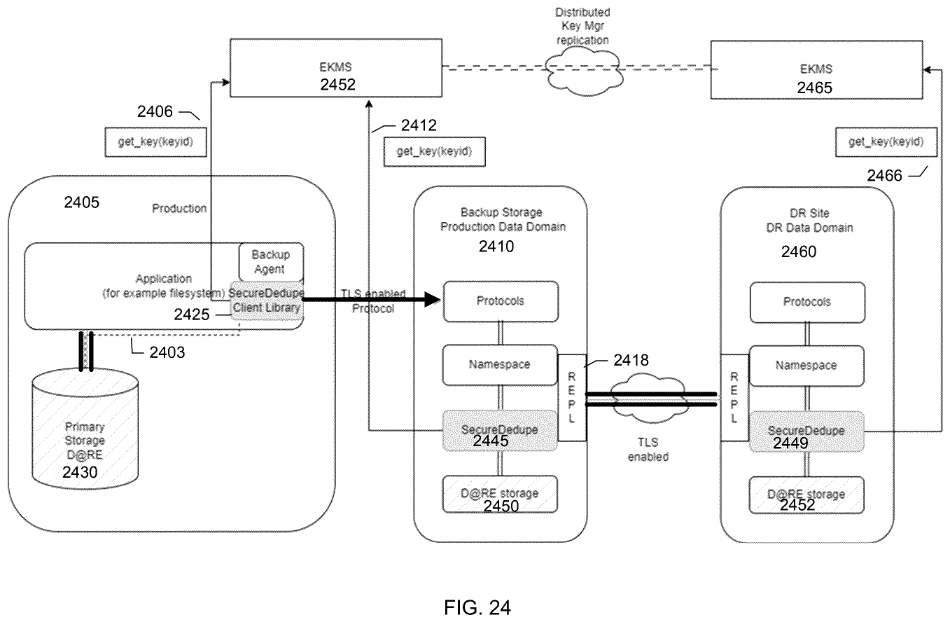

FIG. 24 shows a block diagram for disaster recovery using secure deduplication and an EKMS. As discussed, EKMS is a scalable method to use multiple keys. In an embodiment, systems and techniques allow for secure deduplication with EKMS across sites. The system shown in FIG. 24 is similar to the system shown in FIG. 15. For example, there is a production environment 2405 and a production data protection or backup system 2410 (e.g., Data Domain). The production environment includes an application, backup agent, secure deduplication client library 2425, and primary storage 2430 having data-at-rest-encryption (DARE) storage. The production data protection or backup system includes a deduplication filesystem with a protocols layer, followed by a namespace layer, followed by a secure deduplication layer 2445, followed by protection backup storage 2450 having data-at-rest-encryption. An EKMS 2452 is accessible by the secure deduplication client library at the client and secure deduplication server at the data protection appliance.

The system shown in FIG. 24 further includes a disaster recovery site having a second data protection appliance 2460 and second EKMS 2465. Keys may be replicated between (first) EKMS 2452 and second EKMS 2465. The EKMS system shown in FIG. 24 may be referred to as a distributed key management system. In an embodiment, there can be multiple, e.g., two or more EKMSs, where keys are replicated among each of the different EKMSs. The second data protection appliance likewise includes a deduplication filesystem with a protocols layer, followed by a namespace layer, followed by a secure deduplication layer 2449, followed by disaster recovery storage 2452 having data-at-rest-encryption. Having a second EKMS at the disaster recovery site helps to reduce latency with retrieving keys and provide redundancy as the disaster recovery site may be geographically remote from the production backup storage system.

Table G below shows a flow for FIG. 24.

TABLE G

| Step | Description |
|---|---|
| 1 | The backup is triggered. The data is read 2403 off the primary storage. The secure |
| | deduplication client library may read encrypted data directly off the primary storage. |
| 2 | The encrypted data is decrypted by the secure deduplication client library using a key |
| | which can be accessed from the EKMS using a keyid 2406. Then as part of DDBoost |
| | processing, the data is anchored and segmented. The fingerprints are then filtered |
| | against the protection deduplication storage system (e.g., DDFS). |
| 3 | The new data is encrypted by the secure deduplication client library, using another key |
| | which is also accessed from the EKMS and then sent over the wire. |
| 4 | The data is decrypted on secure deduplication server 2445 using a key looked up 2412 |
| | by the server component, where it decrypted, packed into storage containers and then |
| | written to the D@RE enabled storage. |
| 5 | In an embodiment the key used by the D@RE storage on the production system may be |
| | different from the key used by the secure deduplication client library and secure |
| | deduplication layer component at the server, and the D@RE storage on the protection |
| | storage. |
| 6 | The EKMS system allows for multiplicity of these keys. The EKMS systems expects a |
| | keyid to lookup the corresponding key, which may be used to encrypt or decrypt the |
| | data. |
| 7 | Once the data lands on the protection storage, the data is replicated 2418 to the disaster |
| | recovery (DR) site using one of the two techniques. Managed File Replication (MFR) is |
| | DDBoost integrated application directed. The application instructs the primary |
| | protection storage to replicate the given file to the DR site. The other technique is |
| | snapshot replication (Mtree replication). This technique creates a snapshot on the source |
| | namespace, which is the compared against the last transferred snapshot on the replica. |
| | The new and modified files are transferred over (using the filtering process). Regardless |
| | of the replication method, the data transfer is bandwidth optimized, e.g., only the new |
| | data needs to be sent across the wire. The new data is encrypted by the secure |
| | deduplication layer using a key which is looked up from the EKMS. The encrypted |
| | buffers are then sent over the wire to the DR protection storage. |
| 8 | Upon receiving the new data buffers, the secure deduplication layer 2449 in the DR |
| | protection storage decrypts the buffers received from the replication protocol using the |
| | key looked up 2466 from the (second) EKMS. These buffers are validated and then |
| | written to the DR protection storage 2452. |
| 9 | In an embodiment, the EKMS at the DR site is different from the one in the primary |
| | production site. The EKMS includes processes to synchronize keys using secure |
| | replication processes. |

In an embodiment, the secure deduplication technique encrypts all data which is being read off the DR protection storage as well, while enabling the storage efficiency. In this embodiment, the key used by the D@RE storage on the production system is the same as the key used by the secure deduplication client library and secure deduplication component or layer at the server, and the D@RE storage on the protection storage.

Furthermore, this technique may also encapsulate the granular encryption technique previously described. To summarize, each file may store the keyid as an extended attribute. The keyid is also replicated to the DR site and can be used to look up the EKMS. The key returned from EKMS is used to encrypt the data when it is read from the protection storage.

Thus, even if an unauthorized actor did manage to read the data from the protection storage either on the primary protection storage or the DR protection storage, the data stream would be gibberish. This would thwart the data exfiltration attack.

The authorized user (the backup software or application) could decrypt the data stream by looking up the keyid stored with EKMS.

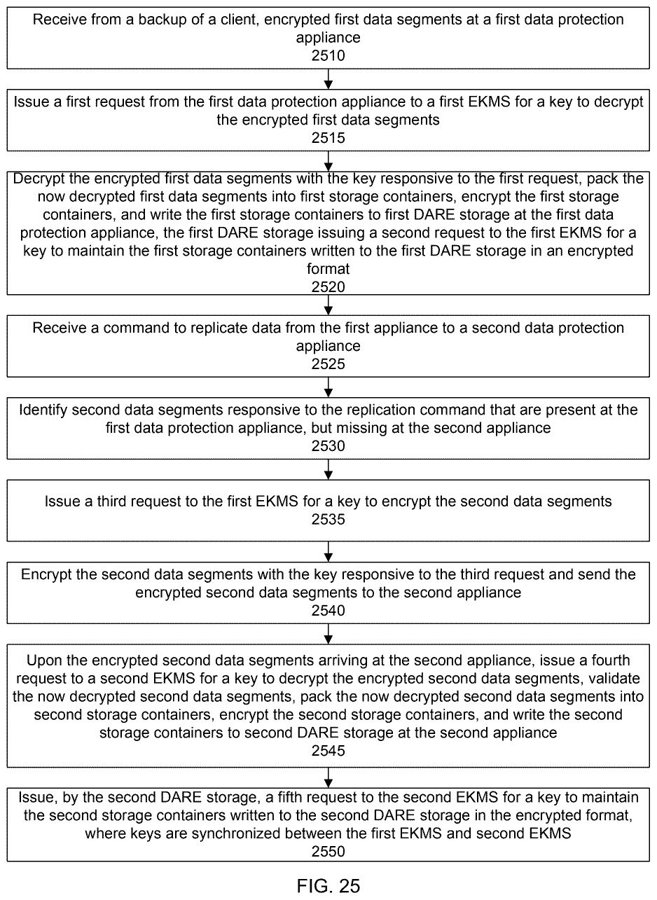

FIG. 25 shows a flow for secure deduplication in disaster recovery with an EKMS, according to one or more embodiments. In a step 2510, encrypted first data segments from a backup of a client are received at a first data protection appliance. In a step 2515, a first request is issued from the first data protection appliance to a first EKMS for a key to decrypt the encrypted first data segments.

In a step 2520, the encrypted first data segments are decrypted with the key responsive to the first request. The now decrypted first data segments are packed into first storage containers and the first storage containers are encrypted and written to first DARE storage at the first data protection appliance. The first DARE storage may issue a second request to the first EKMS for a key to maintain the first storage containers written to the first DARE storage in an encrypted format.

In a step 2525, a command is received to replicate data from the first appliance to a second data protection appliance.

In a step 2530, an identification is made of second data segments responsive to the replication command that are present at the first data protection appliance, but missing at the second data protection appliance. In a step 2535, a third request is issued to the first EKMS for a key to encrypt the second data segments. In a step 2540, the second data segments are encrypted with the key responsive to the third request. The encrypted second data segments are sent to the second data protection appliance.

In a step 2545, upon the encrypted data segments arriving at the second data protection appliance, a fourth request is issued to a second EKMS for a key to decrypt the encrypted second data segments. The second data segments are decrypted and the now decrypted second data segments are validated and packed into to second storage containers. The second storage containers are encrypted and written to second DARE storage at the second data protection appliance.

In a step 2550, the second DARE storage issues a fifth request to the second EKMS for a key to maintain the second storage containers written to the second DARE storage in the encrypted format. Keys are synchronized between the first EKMS and the second EKMS.

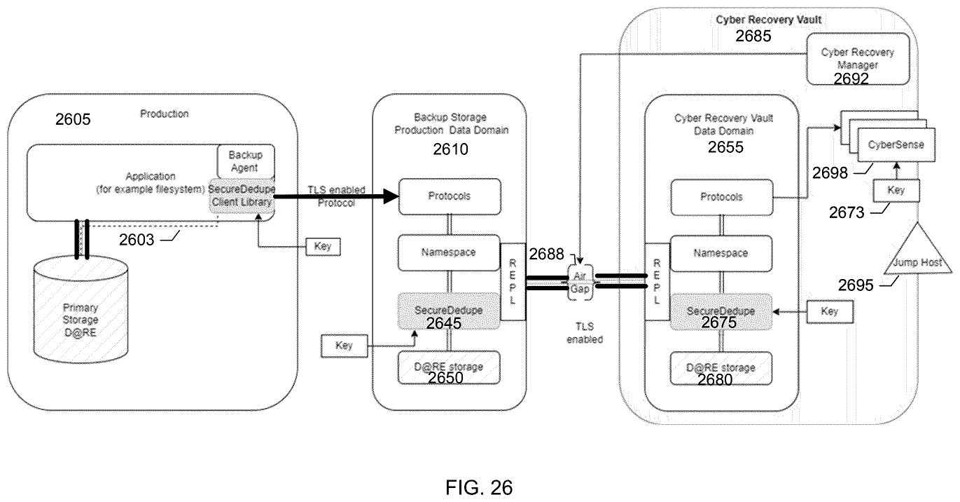

FIG. 26 shows a block diagram of secure deduplication in conjunction with a cyber recovery vault system, according to one or more embodiments. The system shown in FIG. 26 is similar to the system shown in FIG. 22. For example, there is a production environment 2605 and a production data protection or backup appliance 2610 (e.g., Data Domain). The production environment includes an application, backup agent, secure deduplication client library, and primary storage having data-at-rest-encryption (DARE) storage. The production data protection or backup system includes a deduplication filesystem with a protocols layer, followed by a namespace layer, followed by a secure deduplication layer 2645, followed by protection backup storage 2650 having data-at-rest-encryption.

There is a second data protection appliance 2655. The second data protection appliance may be similar to the first data protection appliance. For example, the second data protection appliance includes a deduplication filesystem with a protocols layer, followed by a namespace layer, followed by a secure deduplication layer 2675, followed by protection backup storage 2680 having data-at-rest-encryption. In an embodiment, the first and second data protection appliance are configured for replication. Specifically, backups from clients to the first data protection appliance may be replicated to the second data protection appliance. The replicated backups may be referred to as a replica.

In the example shown in FIG. 26, the second data protection appliance is placed in a cyber recovery vault 2685. The vault is connected to the first data protection appliance via an air gap 2688. The vault includes a cyber recovery manager 2692, jump host 2695, and scanning service 2698.

The jump host isolates the vault from production and backup networks. In an embodiment, to access the vault, a user or administrative user logs into the jump host. The jump host may implement enhanced authentication that requires multi-factor authentication (MFA) and strict user access controls. The user may be allowed only specific operations such as verifying backups or recovering data. Actions may be logged and monitored to help detect suspicious behavior. Access to the second data protection appliance placed in the vault may be more tightly controlled and restricted as compared to the first data protection appliance that does not reside in the vault.

More particularly, the air gap, controlled by the cyber recovery manager may be closed only during periods of replication of data from the first data protection appliance to the second data protection appliance. During other times, the air gap may remain open, thereby protecting the vault from other outside access.

The vault system offers multiple layers of protection to provide resilience against cyber-attacks including insider threats. In an embodiment, the vault is designed to be physically isolated within a protected part of the data center and requires separate security credentials and multi-factor authentication for access. The automated operational air gap provides network isolation and closing of the air gap is restricted to periods of replication with the primary backup data protection appliance. In other words, when the air gap is closed, the vault can be accessed; and when the air gap is open, the vault is cut-off from access.

The scanning service of the vault is responsible for scanning the replicated files and other data for malware. In an embodiment, the scanning service may be provided by a third-party. That is, the scanning service may be provided by a vendor different from a vendor of the data protection appliance with deduplication filesystem. An example of a scanning service is CyberSense®, as provided by Index Engines.

Thus, in an embodiment, the cyber vault is an air-gapped environment, which protects data by making immutable copies of the data. Such a system is inaccessible from outside the vault and therefore reduces the surface area of attacks for cyber criminals. An example of a cyber vault is PowerProtect Cyber Recovery Solution, as provided by Dell. In an embodiment, a vault includes an intelligence system to scan the data for malware. For example, the scanning service (e.g., CyberSense) examines the backups for ransomware, and alerts the customers if there were are any infections detected.

As discussed, during a backup process the data is read off the production storage and sent to the deduplication aware protection storage (e.g., production Data Domain). The transfer of the data is bandwidth optimized (if DDBoost is used). Once the data lands on the protection storage it is replicated to the Cyber Recovery Vault Data Domain using an air-gapped link. The air-gap is operated from within the vault network. At the appropriate time, the Cyber Recovery solution closes the air-gap, so that the data could be transferred over.

In an embodiment, the Cyber Recovery Vault employs snapshot replication (which may be referred to as called M tree replication). This technique creates a snapshot on the source namespace (e.g., production Data Domain), which is the compared against the last transferred snapshot on the replica (e.g., Cyber Recovery Vault Data Domain). The new and modified files are transferred over (using the bandwidth optimized filtering process).

Over the wire traffic secured by TLS. Once the snapshot is replicated to the Cyber Recovery Vault Data Domain, the data (a point in time copy) is made immutable using advanced retention lock methods. This copy may be examined for ransomware. CyberSense employs advanced machine learning algorithms to scan for ransomware in the data-stream, as the data is read off the cyber vault Data Domain.

If the data written to the production Data Domain were encrypted by the application, the data which is replicated to the Cyber Recovery Data Domain will also be encrypted. A scanning service such as CyberSense cannot work with encrypted data stream. This is because encryption introduces entropy, and the machine learning algorithms are trying for pattern matches for known ransomware signatures. Therefore, the problem of choosing security or data reduction, extends to the choice of being cyber resilient in the vault.

Table H below shows a flow for FIG. 26.

TABLE H

| Step | Description |
|---|---|
| 1 | The backup is triggered. The data is read 2603 off the primary storage. The secure |
| | deduplication client library may read encrypted data directly off the primary storage. |
| 2 | The encrypted data is decrypted by the secure deduplication client library, and then as |
| | part of DDBoost processing, the data is anchored and segmented. The fingerprints are |
| | then filtered against the production Data Domain (production deduplication data |
| | protection storage system). |
| 3 | The new data is encrypted by the secure deduplication client library and then sent over |
| | the wire, where it decrypted, packed into storage containers and then written to the |
| | D@RE enabled storage on the production Data Domain. |
| 4 | As the data lands on the production Data Domain, the data is replicated to the Cyber |
| | Recovery Vault (CR) using the snapshot replication (Mtree replication), when the airgap |
| | to the Cyber Recovery Vault is closed. Mtree replication creates a snapshot on the |
| | source namespace (on the production Data Domain), which is then compared against the |
| | last transferred snapshot on the replica (Cyber Recovery Data Domain). The new and |
| | modified files are transferred over (using the bandwidth optimized filtering process). |
| | The new data is encrypted by the secure deduplication layer as it is read by the |
| | replication module, in the production Data Domain, using the key and then sent over the |
| | wire to the Cyber Recovery Vault Data Domain. |
| 5 | Upon receiving the data buffers from the replication module, the secure deduplication |
| | layer in the Cyber Recovery Data Domain decrypts the buffers. These buffers are |
| | validated and then written to the Cyber Recovery Vault Data Domain storage. |
| 6 | The scanning service, e.g., CyberSense reads the point-in-time copy (files in the |
| | replicated snapshot) to inspect them for ransomware. Secure deduplication encrypts all |
| | data which is being read off the Cyber Recovery Data Domain using the key. The |
| | scanning service, e.g., CyberSense, is provided the key 2673 so that it is able to decrypt |
| | the data stream as it is being read for inspection. |

In an embodiment the key used by the D@RE storage on the production system is the same as the key used by the secure deduplication client library and secure deduplication layer at the production Data Domain and secure deduplication layer on the Cyber Recovery Data Domain. For inspection, the same key is also known to CyberSense clients. In another embodiment, at least some keys may be different. For example, there can be first, second, third, and fourth keys. The first key (e.g., k1) may be responsible for primary storage D@RE, the second key (e.g., k2) may be for writing to the Data Domain, the third key (e.g., k3) may be the Data Domain's D@RE encryption, and the fourth key (e.g., k4) may be used in the replica.

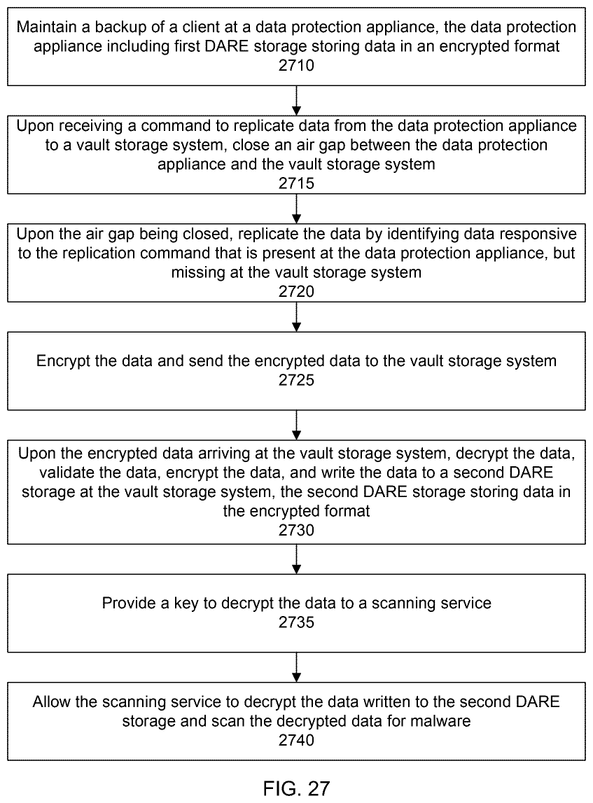

FIG. 27 shows another flow for secure deduplication with a vault. In a step 2710, a backup of a client is maintained at a data protection appliance, the appliance including first DARE storage storing data in an encrypted format. In a step 2715, upon receiving a command to replicate data from the appliance to a vault storage system, an air gap between the appliance and the vault storage system is closed.

In a step 2720, upon the air gap being closed, the data responsive to the replication command that is present at the data protection appliance, but missing at the vault storage system is identified to the vault. In a step 2725, the data is encrypted and sent or transmitted to the vault.

In a step 2730, upon the encrypted data arriving at the vault storage system, the data is decrypted and validated. The data is encrypted and written to second DARE storage at the vault, the second DARE storage storing data in the encrypted format.

In a step 2735, a key to decrypt the data written to second DARE storage is provided to a scanning service. The scanning service may be provided with a key used by the second DARE storage.

In a step 2740, the scanning service is allowed to decrypt the data written to the second DARE storage and scan the decrypted data for malware. In an embodiment, the second DARE storage may remove the DARE encryption upon the read requests, but the data may still be in an encrypted format as a result of having been encrypted by the secure deduplication layer. The scanning service may be provided with the key used by the secure deduplication layer so that the scanning service can convert the data to clear text and thus scan for malware.

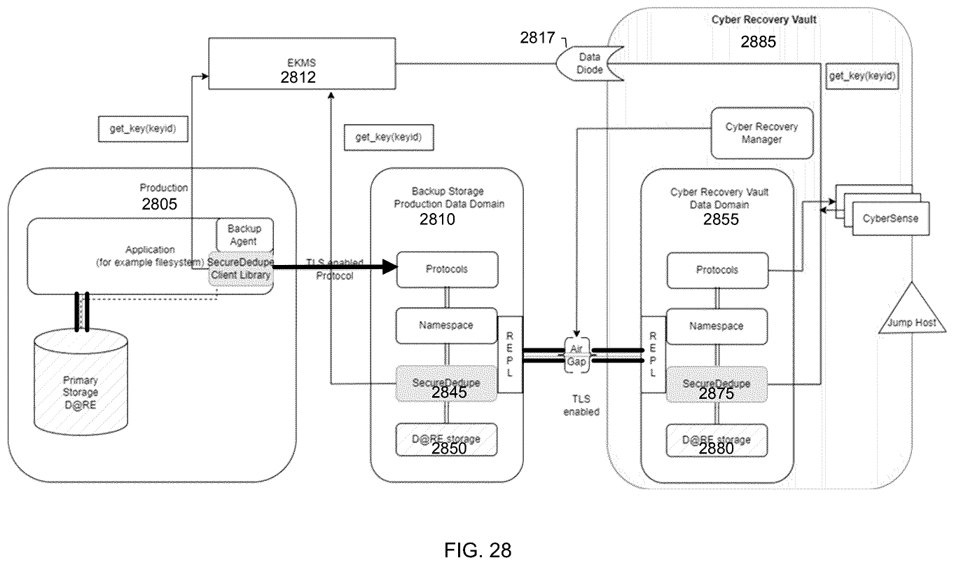

FIG. 28 shows a block diagram of secure deduplication in conjunction with a cyber recovery vault and EKMS, according to one or more embodiments. The system shown in FIG. 28 is similar to the system shown in FIG. 26. For example, there is a production environment 2805 and a production data protection or backup appliance 2810 (e.g., Data Domain). The production environment includes an application, backup agent, secure deduplication client library, and primary storage having data-at-rest-encryption (DARE) storage. The production data protection or backup system includes a deduplication filesystem with a protocols layer, followed by a namespace layer, followed by a secure deduplication layer 2845, followed by protection backup storage 2850 having data-at-rest-encryption.

There is a second data protection appliance 2855. The second data protection appliance may be similar to the first data protection appliance. For example, the second data protection appliance includes a deduplication filesystem with a protocols layer, followed by a namespace layer, followed by a secure deduplication layer 2875, followed by protection backup storage 2880 having data-at-rest-encryption. In an embodiment, the first and second data protection appliance are configured for replication. Specifically, backups from clients to the first data protection appliance may be replicated to the second data protection appliance. The replicated backups may be referred to as a replica. The second data protection appliance is placed in a cyber recovery vault 2885. The vault is connected to the first data protection appliance via an air gap. The vault includes a cyber recovery manager, jump host, and scanning service.

The example shown in FIG. 28 includes an EKMS 2812 to provide central management and generation of the keys. In an embodiment, the EKMS is external or outside of the vault. A data diode 2817 is connected between the EKMS and vault. In an embodiment, a data diode is a hardware-based cybersecurity device that enforces one-way data flow between two network segments. The data diode protects the data protection appliance within the vault by enforcing a one-way access. Thus, in this embodiment, EKMS access from within the cyber recovery vault is routed through the data diode. The data diode is a highly secure networking element which allows one-way access of specific protocol. Therefore, with the data diode, the EKMS access is allowed from within the vault, but there is still no access from outside the vault. The data diode is a highly specialized device that allows initializing the protocol from one or a single direction and makes sure that unintended traffic does not flow through. In an embodiment, the secure deduplication server present with the data protection appliance in the vault initiates the request to the EKMS through the data diode. The request includes the keyid and asks for the key corresponding to the keyid. The response to the request is the key to decrypt the data that may be allowed by the diode back to the requesting secure deduplication server in the vault. The response from the EKMS back through the diode to the requesting secure deduplication server within the vault is limited to the requested key. For example, other attempts to communicate with, access, connect, or establish a connection to the data protection appliance in the vault through the diode are blocked.

Table I below shows a flow for FIG. 28.

TABLE I

| Step | Description |
|---|---|
| 1 | The backup is triggered. The data is read off the primary storage. The secure |
| | deduplication client library may read encrypted data directly off the primary storage. |
| 2 | The encrypted data is decrypted by the secure deduplication client library using a key |
| | which can be accessed from the EKMS using a keyid. As part of DDBoost processing, |
| | the data is anchored and segmented. The fingerprints are then filtered against the |
| | protection deduplication storage system (e.g., Production Data Domain). |
| 3 | The secure deduplication client library encrypts the new data, using another key (which |
| | is accessed from the EKMS) and the encrypted buffers are then sent over the wire. |
| 4 | The data buffers are decrypted on the Production Data Domain's secure deduplication |
| | layer using a key looked up from the EKMS. The data buffers are decrypted, validated |
| | and then packed into storage containers and then written to the D@RE enabled storage. |
| 5 | In this embodiment the key used by the D@RE storage on the production system may |
| | be different from the key used by the secure deduplication client library and secure |
| | deduplication server layer at the Production Data Domain. |
| 6 | The EKMS system allows for multiplicity of these keys. The EKMS systems expects a |
| | keyid to lookup the corresponding key, which may be used to encrypt or decrypt the |
| | data. |
| 7 | As the data lands on the Production Data Domain, the data is replicated to the Cyber |
| | Recovery Vault (CR) using the snapshot replication (Mtree replication), when the airgap |
| | to the Cyber Recovery Vault is closed. Mtree replication creates a snapshot on the |
| | source namespace (on the Production Data Domain), which is then compared against the |
| | last transferred snapshot on the replica (Cyber Recovery Data Domain). The new and |
| | modified files are transferred over (using the bandwidth optimized filtering process). |
| | The new data is encrypted by the secure deduplication layer as it is read by a replication |
| | module, in the Production Data Domain using a key which is looked up from the |
| | EKMS. The encrypted buffers are then sent over the wire to the Cyber Recovery Vault |
| | Data Domain (e.g., second data protection appliance). |
| 8 | Upon receiving the new data buffers, the secure deduplication layer in the Cyber |
| | Recovery Vault Data Domain decrypts the buffers received from the replication protocol |
| | using the key looked up from the EKMS. These buffers are validated and then written to |
| | D@RE storage. |

As discussed, the secure deduplication technique allows for storage efficiency, while enabling the security (by encrypting all egress data streams with the key intended).

In an embodiment, the technique described in table I also encapsulates the granular encryption technique described in the sections above. To summarize, each file may store the keyid as an extended attribute. The keyid is also replicated to the Cyber Recovery Data Domain and can be used to look up the corresponding key in the EKMS. The key returned from EKMS may be used to encrypt the data when it is read from the Cyber Recovery Vault storage.

Thus, even if an unauthorized actor did manage to read the data from the protection storage either on the production or the Cyber Recovery Data Domains, the data stream would be gibberish. This would thwart any data exfiltration attack. Authorized users (like the backup software or application), or CyberSense may decrypt the data stream by looking up the keyid stored with EKMS. In an embodiment, the keyid is part of the file metadata, and is part of the backup software's catalog.

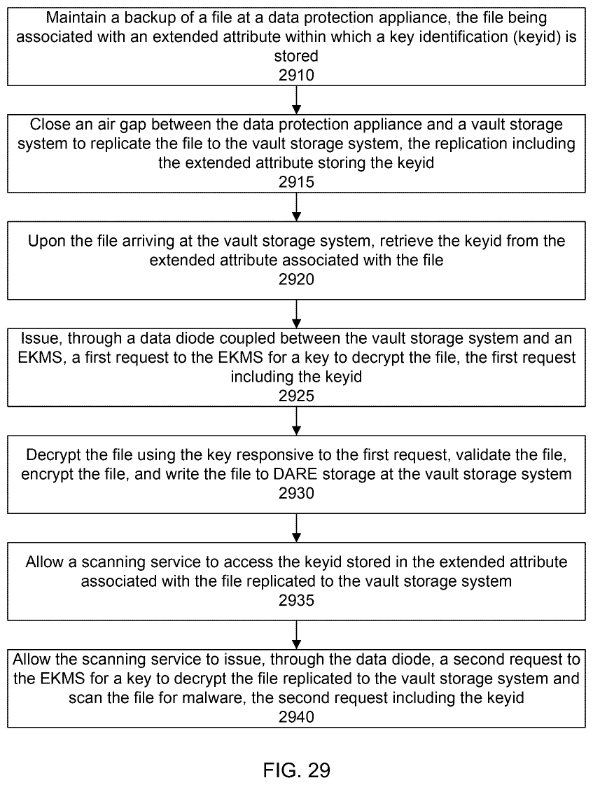

FIG. 29 shows another flow for secure deduplication in connection with a vault storage system and EKMS, according to one or more embodiments. In a step 2910, a backup of a file is maintained at a data protection appliance. The file is associated with or includes an extended attribute within which a key identification (keyid) is stored.

In a step 2915, an air gap between the data protection appliance and a vault storage system is closed to replicate the file to the vault storage system, the replication including the extended attribute storing the keyid.

In a step 2920, upon the file (or, more particularly, new portions or segments of the file) arriving at the vault storage system, the keyid is retrieved from the extended attribute associated with the file.

In a step 2925, a first request is issued to an EKMS through a data diode connected between the vault storage system and the EKMS for a key to decrypt the file, the first request including the keyid. The data diode limits communications back through the diode to the requested key from the EKMS. Other communications or attempts to connect to the vault storage system through the data diode are blocked.

In a step 2930, the file is decrypted using the key responsive to the first request. The file is validated, encrypted, and written to DARE storage at the vault storage system.

In a step 2935, a scanning service is allowed to access the keyid stored in the extended attribute associated with the file replicated to the vault storage system.

In a step 2940, the scanning service is allowed to issue, through the data diode, a second request to the EKMS for a key to decrypt the file replicated to the vault storage system and scan the file for malware, the second request including the keyid. The scanning service can make the request through the data diode independent of a state or mode of the air gap. For example, when the scanning service makes the request for the key, the air gap may be closed or opened. Similarly, the response back to the scanning service with the requested key from the EKMS is independent of the state or mode of the air gap as well. Communications back through the diode are limited to the requested key.

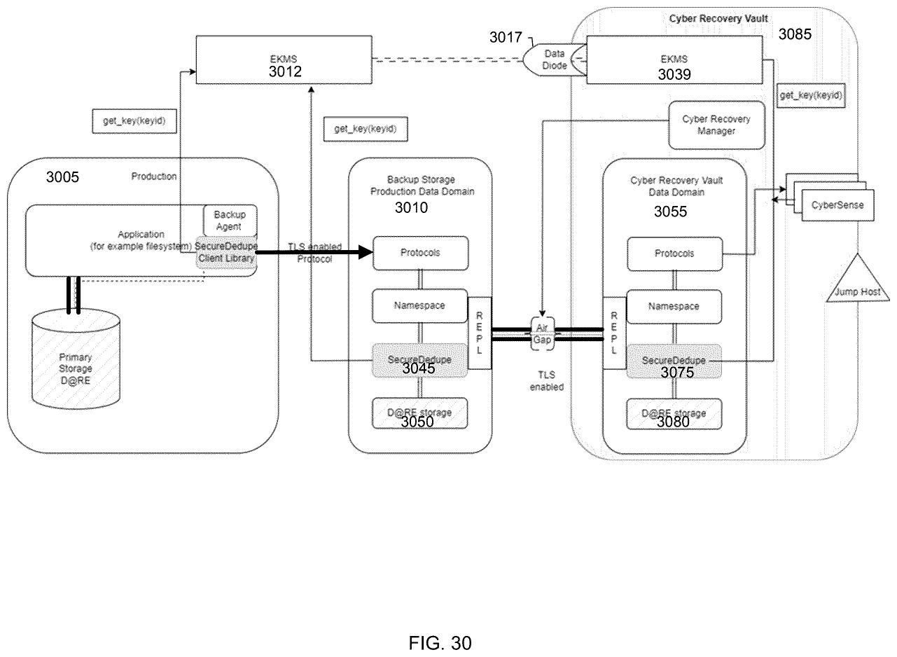

FIG. 30 shows a block diagram of secure deduplication in conjunction with a cyber recovery vault and a vault-internal EKMS, according to one or more embodiments. The system shown in FIG. 30 is similar to the system shown in FIG. 28. For example, there is a production environment 3005 and a production data protection or backup appliance 3010 (e.g., Data Domain). The production environment includes an application, backup agent, secure deduplication client library, and primary storage having data-at-rest-encryption (DARE) storage. The production data protection or backup system includes a deduplication filesystem with a protocols layer, followed by a namespace layer, followed by a secure deduplication layer 3045, followed by protection backup storage 3050 having data-at-rest-encryption.

There is a second data protection appliance 3055. The second data protection appliance may be similar to the first data protection appliance. For example, the second data protection appliance includes a deduplication filesystem with a protocols layer, followed by a namespace layer, followed by a secure deduplication layer 3075, followed by protection backup storage 3080 having data-at-rest-encryption. In an embodiment, the first and second data protection appliance are configured for replication. Specifically, backups from clients to the first data protection appliance may be replicated to the second data protection appliance. The replicated backups may be referred to as a replica. The second data protection appliance is placed in a cyber recovery vault 3085. The vault is connected to the first data protection appliance via an air gap. The vault includes a cyber recovery manager, jump host, and scanning service. A first EKMS 3012 is outside the vault and provides central management and generation of the keys.

In the example of FIG. 30, a data diode 3017 is connected between the first EKMS and a second EKMS 3039 that is placed internal to the vault. For example, the second EKMS may be on a same network as the vault which may be different from a network of the production clients, production data protection backup system, or both. In this embodiment, the EKMS at the Cyber Recovery Vault (e.g., second EKMS) is different from the one in or accessed by the production clients and production backup storage (e.g., first EKMS). A synchronization process, however, allows for synchronizing keys between the first and second EKMS using secure replication methods. In an embodiment, the EKMS synchronization is performed using a secure connection using a data diode. The system shown in FIG. 30 provides a level of redundancy. For example, if the first EKMS should suffer a disaster, data stored within the vault can remain accessible via the second EKMS.

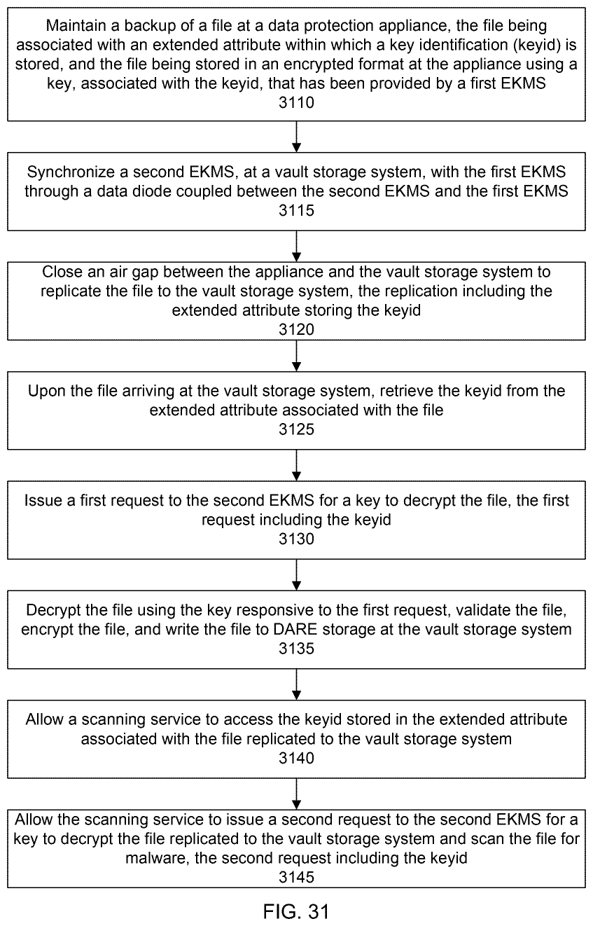

FIG. 31 shows a flow for cyber recovery in conjunction with secure deduplication and a vault-internal EKMS, according to one or more embodiments. In a step 3110, a backup of a file is maintained at a data protection appliance, the file being associated with an extended attribute within which a key identification (keyid) is stored. The file is stored in an encrypted format at the data protection appliance using a key, associated with or mapped to the keyid, that has been provided by a first EKMS.

In a step 3115, a second EKMS at the vault storage system is synchronized with the first EKMS through a data diode connected between the second EKMS and the first EKMS.

In a step 3120, an air gap between the data protection appliance and vault storage system is closed to replicate the file to the vault storage system. The replication includes the extended attribute storing the keyid.

In a step 3125, upon the file arriving at the vault storage system, the keyid is retrieved from the extended attribute associated with the file.

In a step 3130, a first request is issued to the second EKMS for a key to decrypt the file, the first request including the keyid. In this embodiment, the first request does not pass through the data diode because the second EKMS is within the vault or behind the data diode.

In a step 3135, the file is decrypted using the key responsive to the first request. The file is validated, encrypted, and written to DARE storage at the vault storage system.

In a step 3140, a scanning service is allowed to access the keyid stored in the extended attribute associated with the file replicated to the vault storage system.

In a step 3145, the scanning service is allowed to issue a second request to the second EKMS for a key to decrypt the file replicated to the vault storage system and scan the file malware. The second request includes the keyid. In this embodiment, the second request does not pass through the data diode because the second EKMS is within the vault or behind the data diode.

In various embodiments, systems and techniques are provided to achieve end-to-end secure data protection workflows for backups, restores, replication and cyber resiliency with deduplication; provide data protection to protect against data exfiltration while achieving deduplication for operational, disaster and cyber resiliency; provide an end-to-end secure data protection method with deduplication to achieve ingest, restore, replication and cyber resiliency using a singular key; provide an end-to-end secure data protection process with deduplication to achieve ingest, restore, replication and cyber resiliency using EKMS; and achieve granular encryption using secure deduplication.

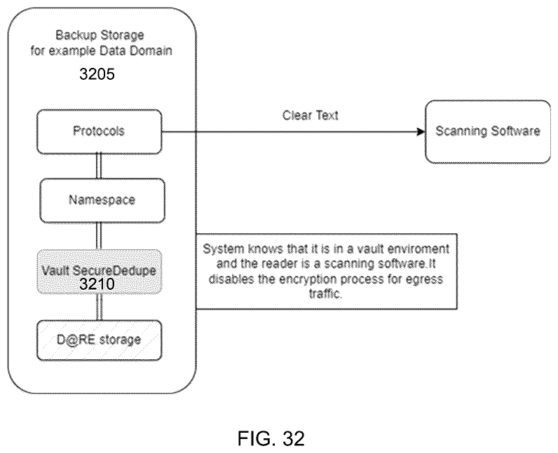

FIG. 32 shows a block diagram of configuring a data protection appliance 3205 for placement inside a vault storage system. In an embodiment, a secure deduplication layer 3210 of the appliance includes a setup or configuration option to indicate placement of the appliance within the vault storage system. Setting the option disables encryption of egress (e.g., read) traffic to allow a scanning service to access clear text. The scanning service does not have to obtain a key. In other words, a key does not have to be shared with the scanning service because the data is provided to the scanning service in an unencrypted format.

In this embodiment, if this system identifies itself as a vault and the reader for the data is the scanning software, then the secure deduplication layer or server component can choose to stop the encryption process for the egress traffic. In an embodiment, this system identification is done once at the system install time and is immutable. This may be referred to as Vault SecureDedupe.

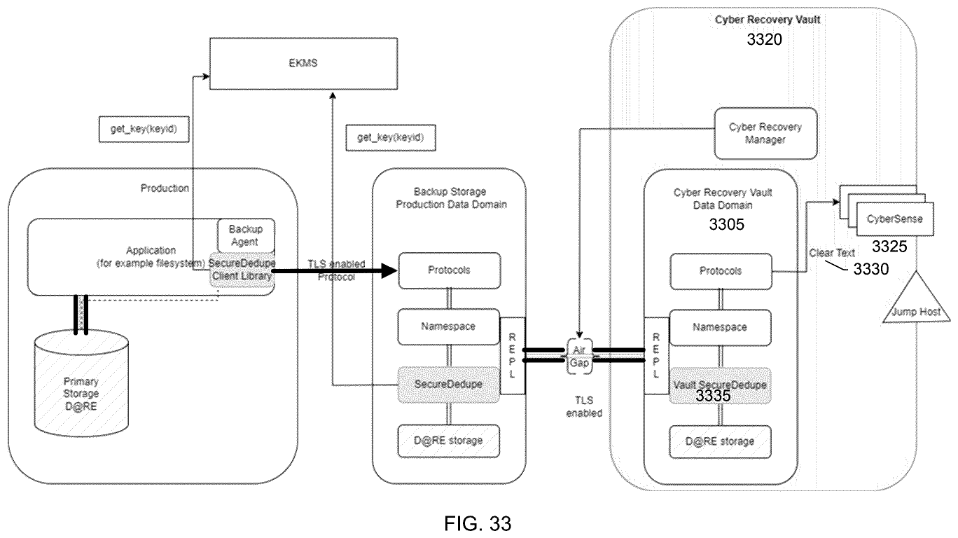

FIG. 33 shows a block diagram of a data protection appliance 3305 having been configured for placement in a vault 3320. The system shown in FIG. 33 is similar to the system shown in FIGS. 26, 28, and 30. In the system of FIG. 33, however, a scanning service 3325 of the vault is provided with clear text 3330. A secure deduplication layer 3335 of the data protection appliance, based on the vault configuration setting, automatically disables encryption (or automatically decrypts encrypted data) for read IO requested by the scanning service.

The advantage of such a model is that the EKMS link through the data diode or an EKMS within the vault may not be required. There is also no key shared with the scanning software (e.g., CyberSense).

Such a model reduces complexity, while allowing the rest of the system (the production storage, the production protection storage, and its replicas) to be protected with secure deduplication enabled encryption. While this can be less secure than having secure deduplication in the vault too, this may be acceptable to certain customers, because the vault itself is air-gap isolated.

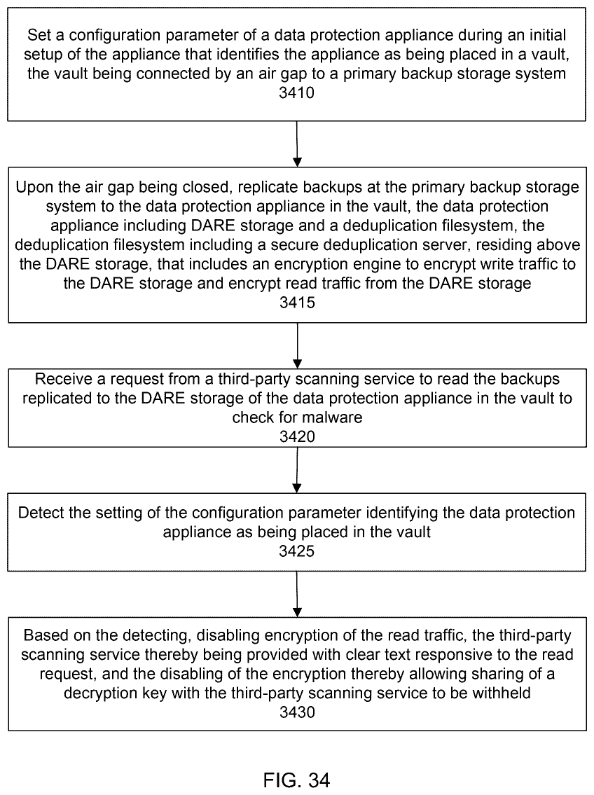

FIG. 34 shows a flow for placement of a data protection appliance in a vault storage system, according to one or more embodiments. In a step 3410, a configuration parameter of a data protection appliance is set during an initial setup of the appliance that identifies or indicates the appliance as being placed in a vault, the vault being connected by an air gap to a primary backup storage system.

In a step 3415, upon the air gap being closed, backups at the primary backup storage system are replicated to the data protection appliance in the vault. The data protection appliance includes data-at-rest-encryption (DARE) storage and a deduplication filesystem. The deduplication filesystem includes a secure deduplication server, residing above the DARE storage, that includes an encryption engine to encrypt write traffic to the DARE storage and encrypt read traffic from the DARE storage.

In a step 3420, a request is received by the deduplication filesystem from a third-party scanning service to read the backups replicated to the DARE storage of the data protection appliance in the vault to check for malware.

In a step 3425, a detection is made of the configuration setting identifying the data protection appliance as being placed in the vault.

In a step 3430, based on the detection, the encryption of the read traffic is disabled. The third-party scanning service is thereby provided with clear text responsive to the read request. The disabling of the encryption allows sharing of a decryption key with the third-party scanning service to be withheld. That is, the key can remain retained, concealed, or hidden by the secure deduplication server component from the third-party scanning service.

In an embodiment, a method includes: backing up a client by reading encrypted data segments from a primary storage of the client into a secure deduplication library installed at the client, the primary storage comprising a first data-at-rest-encryption (DARE) storage; decrypting the encrypted data segments and deduplicating the now unencrypted data segments against existing data segments being managed by a data protection appliance, coupled to the client, to identify new data segments; encrypting the new data segments and transmitting the encrypted new data segments to the data protection appliance, the data protection appliance comprising a deduplication filesystem, the deduplication filesystem comprising a secure deduplication layer above a storage layer, the storage layer comprising a second DARE storage; and upon the secure deduplication layer receiving the encrypted new data segments, decrypting the encrypted new data segments, packing the now decrypted new data segments into storage containers, and writing the storage containers to the second DARE storage.

The method may include a first key associated with the first DARE storage, a second key associated with the encrypting the new data segments and transmitting to the data protection appliance, and a third key associated with the second DARE storage, wherein the first, second, and third keys are the same.

The method may include a first key associated with the first DARE storage, a second key associated with the encrypting the new data segments and transmitting to the data protection appliance, and a third key associated with the second DARE storage, wherein the first key is different from the second and third keys, and the second key is different from the third key.

The method may include: receiving a restoration request from the client; issuing read IOs from the secure deduplication layer to the storage layer comprising the second DARE storage for data segments responsive to the restoration; encrypting the data segments responsive to the restoration before handing the now encrypted data segments responsive to the restoration to a namespace layer, above the secure deduplication layer, for transmission by a protocol layer, above the namespace layer, to the client; upon receiving the encrypted data segments responsive to the restoration at the secure deduplication library at the client, decrypting the received data segments and validating the now decrypted received data segments; and after the validating, encrypting the received data segments, and writing the received and now encrypted data segments to the first DARE storage.

In an embodiment, the backing up a client by reading encrypted data segments from a primary storage of the client into a secure deduplication library installed at the client comprises: loading data responsive to the backup into memory of the client, the data loaded into the memory being in an encrypted format.

The writing the storage containers to the second DARE storage may include encrypting the storage containers before writing to the second DARE storage.

In an embodiment, there is a system comprising: a processor; and memory configured to store one or more sequences of instructions which, when executed by the processor, cause the processor to carry out the steps of: backing up a client by reading encrypted data segments from a primary storage of the client into a secure deduplication library installed at the client, the primary storage comprising a first data-at-rest-encryption (DARE) storage; decrypting the encrypted data segments and deduplicating the now unencrypted data segments against existing data segments being managed by a data protection appliance, coupled to the client, to identify new data segments; encrypting the new data segments and transmitting the encrypted new data segments to the data protection appliance, the data protection appliance comprising a deduplication filesystem, the deduplication filesystem comprising a secure deduplication layer above a storage layer, the storage layer comprising a second DARE storage; and upon the secure deduplication layer receiving the encrypted new data segments, decrypting the encrypted new data segments, packing the now decrypted new data segments into storage containers, and writing the storage containers to the second DARE storage.

In an embodiment, there is a computer program product, comprising a non-transitory computer-readable medium having a computer-readable program code embodied therein, the computer-readable program code adapted to be executed by one or more processors to implement a method comprising: backing up a client by reading encrypted data segments from a primary storage of the client into a secure deduplication library installed at the client, the primary storage comprising a first data-at-rest-encryption (DARE) storage; decrypting the encrypted data segments and deduplicating the now unencrypted data segments against existing data segments being managed by a data protection appliance, coupled to the client, to identify new data segments; encrypting the new data segments and transmitting the encrypted new data segments to the data protection appliance, the data protection appliance comprising a deduplication filesystem, the deduplication filesystem comprising a secure deduplication layer above a storage layer, the storage layer comprising a second DARE storage; and upon the secure deduplication layer receiving the encrypted new data segments, decrypting the encrypted new data segments, packing the now decrypted new data segments into storage containers, and writing the storage containers to the second DARE storage.

In an embodiment, there is a method comprising: backing up a client by reading encrypted data segments from a primary storage of the client into a secure deduplication library installed at the client, the primary storage comprising a first data-at-rest-encryption (DARE) storage; issuing a first request from the client to an external key management system (EKMS) for a key to decrypt the encrypted data segments; decrypting the encrypted data segments with the key responsive to the first request and deduplicating the now unencrypted data segments against existing data segments being managed by a data protection appliance to identify new data segments; issuing a second request to the EKMS for a key to encrypt the new data segments; encrypting the new data segments using the key responsive to the second request and sending the encrypted new data segments to the data protection appliance, the data protection appliance comprising a second DARE storage; issuing a third request from the data protection appliance to the EKMS for a key to decrypt the encrypted new data segments; decrypting the encrypted new data segments with the key responsive to the third request, packing the now decrypted new data segments into storage containers, and writing the storage containers to the second DARE storage; upon a restoration request from the client, issuing read IOs to the second DARE storage for data segments responsive to the restoration; decrypting the data segments responsive to the restoration and copying the decrypted data segments into data buffers; issuing a fourth request from the data protection appliance to the EKMS for a key to encrypt the data buffers comprising the data segments responsive to the restoration; encrypting the data buffers with the key responsive to the fourth request and sending the encrypted data buffers to the client; upon receiving the encrypted data buffers at the secure deduplication library at the client, issuing a fifth request from the client to the EKMS for a key to decrypt the data buffers and validating the now decrypted data buffers; and after the validating, issuing a fifth request from the client to the EKMS for a key to encrypt the data segments of the data buffers, and writing the now encrypted data segments of the data buffers to the first DARE storage.

In an embodiment, there is a method comprising: reading encrypted data segments from a primary storage of a client into a secure deduplication library installed at the client, the primary storage comprising a first data-at-rest-encryption (DARE) storage; issuing a first request from the client to an external key management system (EKMS) for a key to decrypt the encrypted data segments; decrypting the encrypted data segments with the key responsive to the first request and deduplicating the now unencrypted data segments against existing data segments being managed by a data protection appliance to identify new data segments; issuing a second request to the EKMS for a key to encrypt the new data segments; encrypting the new data segments using the key responsive to the second request and sending the encrypted new data segments to the data protection appliance, the data protection appliance comprising a second DARE storage; issuing a third request from the data protection appliance to the EKMS for a key to decrypt the encrypted new data segments; and decrypting the encrypted new data segments with the key responsive to the third request, packing the now decrypted new data segments into storage containers, and writing the storage containers to the second DARE storage.

In an embodiment, there is a method comprising: reading encrypted data segments from a primary storage of a client into a secure deduplication library installed at the client, the primary storage comprising a first data-at-rest-encryption (DARE) storage; issuing a first request from the client to an external key management system (EKMS) for a key to decrypt the encrypted data segments; decrypting the encrypted data segments with the key responsive to the first request and deduplicating the now unencrypted data segments against existing data segments being managed by a data protection appliance to identify new data segments; issuing a second request to the EKMS for a key to encrypt the new data segments; and encrypting the new data segments using the key responsive to the second request and sending the encrypted new data segments to the data protection appliance, the data protection appliance comprising a second DARE storage.

The method may include upon receipt of the encrypted new data segments at the data protection appliance, issuing a third request from the data protection appliance to the EKMS for a key to decrypt the encrypted new data segments; and decrypting the encrypted new data segments with the key responsive to the third request, the decrypting of the new data segments being accompanied by an integrity check on the new data segments;

The method may include packing the now decrypted new data segments into storage containers; encrypting the storage containers; and writing the storage containers to the second DARE storage. The method may include storing a key identifier (keyid) to a key managed by the EKMS to decrypt the encrypted data segments and encrypt the new data segments as an extended attribute of a file comprising the new data segments and data segments. In an embodiment, the data protection appliance comprises a deduplication filesystem, the deduplication filesystem comprising a protocols layer, followed by a namespace layer, and followed by a secure deduplication layer, the secure deduplication layer residing above the second DARE storage. In an embodiment, all data streams arriving at the secure deduplication library arrive encrypted, are decrypted by the secure deduplication library, and are encrypted when exiting the secure deduplication library.

In an embodiment, there is a method comprising: while ingesting a file for backup from a client into a data protection appliance having a deduplication file system, issuing a first request from the client to an external key management system (EKMS) for a key to encrypt the file; storing a key identification (keyid) corresponding to the key as an extended attribute associated with the file on the deduplication file system of the data protection appliance; storing the keyid in a backup catalog of a backup application, the backup catalog being accessible by a backup agent at the client; upon a request to restore the file from the data protection appliance to the client, retrieving the keyid stored as the extended attribute; issuing a second request from data protection appliance to the EKMS for a key to encrypt the file, the second request comprising the keyid retrieved from the extended attribute; encrypting the file with the key responsive to the second request and sending the now encrypted file to the client; accessing, by the client, the backup catalog to retrieve the keyid; and issuing a third request from the client to the EKMS for a key to decrypt the file, the third request comprising the keyid retrieved by the client from the backup catalog.

In an embodiment, there is a method comprising: while ingesting a file for backup from a client into a data protection appliance having a deduplication file system, issuing a first request from the client to an external key management system (EKMS) for a key to encrypt the file; storing a key identification (keyid) corresponding to the key as an extended attribute on the deduplication file system of the data protection appliance; storing the keyid in a backup catalog of a backup application, the backup catalog being accessible by a backup agent at the client; upon a request to restore the file from the data protection appliance to the client, retrieving the keyid stored as the extended attribute; issuing a second request from data protection appliance to the EKMS for a key to encrypt the file, the second request comprising the keyid retrieved from the extended attribute; encrypting the file with the key responsive to the second request and sending the now encrypted file to the client; accessing, by the client, the backup catalog to retrieve the keyid; and issuing a third request from the client to the EKMS for a key to decrypt the file, the third request comprising the keyid retrieved by the client from the backup catalog.

In an embodiment, the extended attribute belongs to the file, the keyid thereby being exclusive to the file. In another embodiment, the extended attribute belongs to a namespace of the file, the keyid thereby also being associated with all other files within the namespace. In an embodiment, the file is a first file, the keyid is a first keyid, and the method further comprises: while ingesting a second file for another backup from the client into the data protection appliance, issuing a fourth request from the client to the EKMS for a key to encrypt the second file; and storing a second keyid corresponding to the key to encrypt the second file as an extended attribute of the second file, wherein the second keyid is different from the first keyid.

In an embodiment, a method includes: receiving, at the data protection appliance, encrypted data segments of the file; decrypting the encrypted data segments; packing the now decrypted data segments into storage containers; encrypting the storage containers; and writing the encrypted storage containers to a data-at-rest-encryption (DARE) storage at the data protection appliance. In an embodiment, the data protection appliance comprises a data-at-rest-encryption (DARE) storage, and the method further comprises: issuing read input/output (IO) to the DARE storage for data segments responsive to the request to restore the file, wherein the DARE storage retrieves and decrypts the data segments before handing the data segments to a secure deduplication layer of a deduplication filesystem residing above the DARE storage; and encrypting the data segments before handing the now encrypted data segments to a namespace layer of the deduplication filesystem, the namespace layer residing above the secure deduplication layer.

In an embodiment, there is a method comprising: backing up a client by reading encrypted data segments from a primary storage of the client into a secure deduplication library installed at the client, the primary storage comprising a first data-at-rest encryption (DARE) storage storing data in an encrypted format; decrypting the encrypted data segments and deduplicating the now unencrypted data segments against existing data segments being managed by a first data protection appliance, coupled to the client, to identify first data segments, the first data segments being at the client, but missing at the first data protection appliance; encrypting the first data segments and sending the encrypted first data segments to the first data protection appliance; upon the encrypted first data segments arriving at the first data protection appliance, decrypting the encrypted first data segments, packing the now decrypted first data segments into first storage containers, and writing the first storage containers to a second DARE storage at the first data protection appliance, the second DARE storage storing data in the encrypted format; receiving a command to replicate data from the first data protection appliance to a second data protection appliance; identifying second data segments responsive to the replication command that are present at the first data protection appliance, but missing at the second data protection appliance; encrypting the second data segments and sending the encrypted second data segments to the second data protection appliance; and upon the encrypted second data segments arriving at the second data protection appliance, decrypting the encrypted second data segments, validating the now decrypted second data segments, packing the now decrypted second data segments into second storage containers, and writing the second storage containers to a third DARE storage of the second data protection appliance, the third DARE storage storing data in the encrypted format.

In an embodiment, there is a method comprising: maintaining, at a first data protection appliance, backups of clients in an encrypted format in first data-at-rest-encryption (DARE) storage of the first data protection appliance using a key; upon a request to replicate the backups to a second data protection appliance, geographically remote from the first data protection appliance, identifying data segments responsive to the replication command that are present at the first data protection appliance, but missing at the second data protection appliance; encrypting the data segments with the key and sending the encrypted data segments to the second data protection appliance; and upon the encrypted data segments arriving at the second data protection appliance, decrypting the encrypted data segments with the key, validating the now decrypted data segments, packing the now decrypted data segments into storage containers, and writing the storage containers to a second DARE storage of the second data protection appliance, the second DARE storage using the key to store data in the encrypted format.

In an embodiment, a method includes: maintaining, at a first data protection appliance, backups of clients in an encrypted format in first data-at-rest-encryption (DARE) storage of the first data protection appliance; receiving a request to replicate the backups to a second data protection appliance, geographically remote from the first data protection appliance; identifying data segments responsive to the replication command that are present at the first data protection appliance, but missing at the second data protection appliance; encrypting the data segments and sending the encrypted data segments to the second data protection appliance; and upon the encrypted data segments arriving at the second data protection appliance, decrypting the encrypted data segments, validating the now decrypted data segments, packing the now decrypted data segments into storage containers, encrypting the storage containers, and writing the encrypted storage containers to a second DARE storage of the second data protection appliance.

In an embodiment, the first DARE storage of the first data protection appliance maintains the backups of the clients in an encrypted format using a key, and the data segments identified as missing at the second data protection appliance are encrypted using the same key. In another embodiment, the first DARE storage of the first data protection appliance maintains the backups of the clients in an encrypted format using a first key, and the data segments identified as missing at the second data protection appliance are encrypted using a second key, different from the first key.

In an embodiment, each of the first and second data protection appliances comprises a deduplication filesystem, the deduplication filesystem comprising a secure deduplication layer residing above each of a respective first or second DARE storage, wherein the secure deduplication layer decrypts incoming data streams to validate data of the incoming data streams and encrypts outgoing data streams to protect data of the outgoing data streams.

In an embodiment, each of the first and second data protection appliances comprises a deduplication filesystem, the deduplication filesystem comprising a protocols layer, followed by a namespace layer, followed by a secure deduplication layer, followed by a storage layer comprising a respective first or second DARE storage, wherein the protocols layer translates protocol requests to filesystem commands, the namespace layer maintains a tree structure organizing metadata of files managed by a respective first or second data protection appliance, and wherein the secure deduplication layer decrypts ingress data segments that have been passed down through the protocols and namespace layers to the secure deduplication layer for validation and packaging, and encrypts egress segments from the storage layer before passing the encrypted egress segments to the namespace layer.

In an embodiment, identifying data segments responsive to the replication command that are present at the first data protection appliance, but missing at the second data protection appliance comprises: creating a snapshot at the first data protection appliance capturing a current state of files at the first data protection appliance; comparing the snapshot against a last snapshot of the second data protection appliance; and based on the comparison, transferring new and modified files to the second data protection appliance.

In an embodiment, there is a method comprising: receiving, from a backup of a client, encrypted first data segments at a first data protection appliance; issuing a first request from the first data protection appliance to a first external key management system (EKMS) for a key to decrypt the encrypted first data segments; decrypting the encrypted first data segments with the key responsive to the first request, packing the now decrypted first data segments into first storage containers, and writing the first storage containers to a first data-at-rest-encryption (DARE) storage at the first data protection appliance, the first DARE storage issuing a second request to the first EKMS for a key to maintain the first storage containers written to the first DARE storage in an encrypted format; receiving a command to replicate data from the first data protection appliance to a second data protection appliance; identifying second data segments responsive to the replication command that are present at the first data protection appliance, but missing at the second data protection appliance; issuing a third request to the first EKMS for a key to encrypt the second data segments; encrypting the second data segments with the key responsive to the third request and sending the encrypted second data segments to the second data protection appliance; and upon the encrypted second data segments arriving at the second data protection appliance, issuing a fourth request to a second EKMS for a key to decrypt the encrypted second data segments, validating the now decrypted second data segments, packing the now decrypted second data segments into second storage containers, and writing the second storage containers to a second DARE storage at the second data protection appliance, wherein the second DARE storage issues a fifth request to the second EKMS for a key to maintain the second storage containers written to the second DARE storage in the encrypted format, and keys are synchronized between the first EKMS and the second EKMS.

In an embodiment, there is a method comprising: maintaining, at a first data protection appliance, backups of clients in an encrypted format in first data-at-rest-encryption (DARE) storage of the first data protection appliance; upon a request to replicate the backups to a second data protection appliance, identifying data segments responsive to the replication command that are present at the first data protection appliance, but missing at the second data protection appliance; issuing a first request to a first external key manager system (EKMS) for a key to encrypt the data segments; encrypting the data segments with the key with the key responsive to the first request and sending the encrypted data segments to the second data protection appliance; upon the encrypted data segments arriving at the second data protection appliance, issuing a second request to a second EKMS, remote from the first EKMS, for a key to decrypt the encrypted data segments; and decrypting the encrypted data segments with the key responsive to the second request, validating the now decrypted data segments, packing the now decrypted data segments into storage containers, and writing the storage containers to a second DARE storage of the second data protection appliance, wherein the second DARE storage issues a third request to the second EKMS for a key to maintain the storage containers written to the second DARE storage in the encrypted format, and keys are synchronized between the first EKMS and second EKMS.

In an embodiment, a method includes: maintaining, at a first data protection appliance, backups of clients in an encrypted format in first data-at-rest-encryption (DARE) storage of the first data protection appliance; upon a request to replicate the backups to a second data protection appliance, identifying data segments responsive to the replication command that are present at the first data protection appliance, but missing at the second data protection appliance; issuing a first request to a first external key manager system (EKMS) for a key to encrypt the data segments; and encrypting the data segments with the key with the key responsive to the first request and sending the encrypted data segments to the second data protection appliance.

The method may include: upon the encrypted data segments arriving at the second data protection appliance, issuing a second request to a second EKMS, remote from the first EKMS, for a key to decrypt the encrypted data segments. The method may include decrypting the encrypted data segments with the key responsive to the second request, validating the now decrypted data segments, packing the now decrypted data segments into storage containers, encrypting the storage containers, and writing the storage containers to a second DARE storage of the second data protection appliance. In an embodiment, the second DARE storage issues a third request to the second EKMS for a key to maintain the storage containers written to the second DARE storage in the encrypted format. In an embodiment, keys are synchronized between the first EKMS and second EKMS.

In an embodiment, each of the first and second data protection appliances comprises a deduplication filesystem, the deduplication filesystem comprising a protocols layer, followed by a namespace layer, followed by a secure deduplication layer, followed by a storage layer comprising a respective first or second DARE storage, wherein the protocols layer translates protocol requests to filesystem commands, the namespace layer maintains a tree structure organizing metadata of files managed by a respective first or second data protection appliance, and wherein the secure deduplication layer decrypts ingress data segments that have been passed down through the protocols and namespace layers to the secure deduplication layer for validation and packaging, and encrypts egress segments from the storage layer before passing the encrypted egress segments to the namespace layer.

In an embodiment, there is a method comprising; maintaining a backup of a client at a data protection appliance, the data protection appliance comprising a first data-at-rest-encryption (DARE) storage storing data in an encrypted format; upon receiving a command to replicate data from the data protection appliance to a vault storage system, closing an air gap between the data protection appliance and the vault storage system; upon the air gap being closed, replicating the data by identifying data responsive to the replication command that is present at the data protection appliance, but missing at the vault storage system; encrypting the data and sending the encrypted data to the vault storage system; and upon the encrypted data arriving at the vault storage system, decrypting the data, validating the data, and writing the data to a second DARE storage at the vault storage system, the second DARE storage storing data in the encrypted format; providing a key for the second DARE storage to a scanning service; and allowing the scanning service to decrypt the data written to the second DARE storage and scan the decrypted data for malware.

In an embodiment, there is a method comprising: maintaining a backup of a client at a data protection appliance, the data protection appliance comprising a first data-at-rest-encryption (DARE) storage storing data in an encrypted format; upon receiving a command to replicate data from the data protection appliance to a vault storage system, closing an air gap between the data protection appliance and the vault storage system; upon the air gap being closed, replicating the data by identifying data responsive to the replication command that is present at the data protection appliance, but missing at the vault storage system; encrypting the data and sending the encrypted data to the vault storage system; upon the encrypted data arriving at the vault storage system, decrypting the data, validating the data, and writing the data to a second DARE storage at the vault storage system, the second DARE storage storing data in the encrypted format; providing a key for the second DARE storage to a scanning service; and allowing the scanning service to decrypt the data written to the second DARE storage and scan the decrypted data for malware.

In an embodiment, there is a method comprising: maintaining a backup of a file at a data protection appliance, the file being associated with an extended attribute within which a key identification (keyid) is stored; closing an air gap between the data protection appliance and a vault storage system to replicate the file to the vault storage system, the replication including the extended attribute storing the keyid; upon the file arriving at the vault storage system, retrieving the keyid from the extended attribute; issuing, through a data diode coupled between the vault storage system and an external key management system (EKMS), a first request to the EKMS for a key to decrypt the file, the first request comprising the keyid; decrypting the file using the key responsive to the first request, validating the file, and writing the file to a data-at-rest-encryption (DARE) storage at the vault storage system; allowing a scanning service to access the keyid stored in the extended attribute replicated to the vault storage system; and allowing the scanning service to issue, through the data diode, a second request to the EKMS for a key to decrypt the file replicated to the vault storage system and scan the file for malware, the second request comprising the keyid.

In an embodiment, a method includes: closing an air gap between a first data protection appliance and a vault storage system comprising a second data protection appliance; upon the air gap being closed, replicating data from the first data protection appliance to the second data protection appliance in the vault storage system; upon the data arriving at the second data protection appliance, encrypting the data before writing the data to a storage layer of the second data protection appliance; receiving, at the second data protection appliance, read requests from a scanning service; providing, to the scanning service, data responsive to the read requests from the storage layer of the second data protection appliance, wherein the data is provided to the scanning service in an encrypted format; and sharing a key with the scanning service to decrypt the data provided to the scanning service.

The method may include encrypting the data before transmitting the data from the first data protection appliance to the second data protection appliance; and decrypting, at the second data protection appliance, the data, validating the data, packing the data into storage containers, encrypting the storage containers, and writing the storage containers to the storage layer of the second data protection appliance, the storage layer of the second data protection appliance comprising a data-at-rest-encryption (DARE) storage.

In an embodiment, the first data protection appliance comprises a first data-at-rest-encryption (DARE) storage that uses a first key, the second data protection appliance comprises a second data-at-rest-encryption (DARE) storage that uses a second key, and the encrypting the data before writing the data to a storage layer of the second data protection appliance is performed using a third key, and wherein the first, second, and third keys are the same.

In an embodiment, the first data protection appliance comprises a first data-at-rest-encryption (DARE) storage that uses a first key, the second data protection appliance comprises a second data-at-rest-encryption (DARE) storage that uses a second key, and the encrypting the data before writing the data to a storage layer of the second data protection appliance is performed using a third key, and wherein the first key is different from the second key and the third key, and the second key is different from the third key.

In an embodiment, there is a method comprising: maintaining a backup of a file at a data protection appliance, the file being associated with an extended attribute within which a key identification (keyid) is stored, and the file being stored in an encrypted format at the data protection appliance using a key, associated with the keyid, that has been provided by a first external key management system (EKMS); synchronizing a second EKMS, at a vault storage system, with the first EKMS through a data diode coupled between the second EKMS and the first EKMS; closing an air gap between the data protection appliance and the vault storage system to replicate the file to the vault storage system, the replication including the extended attribute storing the keyid; upon the file arriving at the vault storage system, retrieving the keyid from the extended attribute; issuing a first request to the second EKMS for a key to decrypt the file, the first request comprising the keyid; decrypting the file using the key responsive to the first request, validating the file, and writing the file to a data-at-rest-encryption (DARE) storage at the vault storage system; allowing a scanning service to access the keyid stored in the extended attribute replicated to the vault storage system; and allowing the scanning service to issue a second request to the second EKMS for a key to decrypt the file replicated to the vault storage system and scan the file for malware, the second request comprising the keyid.

In an embodiment, a method includes: coupling a data diode between an external key manager system (EKMS) and a vault storage system; closing an air gap between a first data protection appliance and the vault storage system, the vault storage system comprising a second data protection appliance; upon the air gap being closed, replicating a file from the first data protection appliance to the second data protection appliance in the vault storage system, the file being associated with an extended attribute within which a key identification (keyid) is stored; encrypting, at the second data protection appliance, the file before writing the file to a storage layer of the second data protection appliance; allowing a scanning service in the vault storage system to retrieve the keyid stored in the extended attribute; and allowing the scanning service to issue, through the data diode, a request to the EKMS for a key to decrypt the file to scan the file for malware, the request comprising the keyid.

In an embodiment, a method includes: positioning a data diode between a first external key manager system (EKMS) and a second EKMS, the second EKMS being in a vault storage system, and keys of the first and second EKMSs being synchronized; closing an air gap between the first data protection appliance and the vault storage system, the vault storage system comprising a second data protection appliance; upon the air gap being closed, replicating a file from the first data protection appliance to the second data protection appliance in the vault storage system, the file being associated with an extended attribute within which a key identification (keyid) is stored; encrypting, at the second data protection appliance, the file before writing the file to a storage layer of the second data protection appliance; allowing a scanning service in the vault storage system to retrieve the keyid stored in the extended attribute; and allowing the scanning service to issue a request to the second EKMS for a key to decrypt the file to scan the file for malware, the request comprising the keyid.

In an embodiment, there is a method comprising: setting a configuration parameter of a data protection appliance during an initial setup of the data protection appliance that identifies the data protection appliance as being placed in a vault, the vault being coupled by an air gap to a primary backup storage system, wherein upon the air gap being closed, backups at the primary backup storage system are replicated to the data protection appliance in the vault, the data protection appliance comprising a data-at-rest-encryption (DARE) storage and a deduplication filesystem, the deduplication filesystem comprising a secure deduplication server, residing above the DARE storage, that comprises an encryption engine to encrypt write traffic to the DARE storage and encrypt read traffic from the DARE storage; receiving a request from a third-party scanning service to read the backups replicated to the DARE storage of the data protection appliance in the vault to check for malware; detecting the setting of the configuration parameter identifying the data protection appliance as being placed in the vault; and based on the detecting, disabling encryption of the read traffic, the third-party scanning service thereby being provided with clear text responsive to the read request, and the disabling of the encryption thereby allowing sharing of a decryption key with the third-party scanning service to be withheld.

In an embodiment, there is a method comprising: setting a configuration parameter of a data protection appliance during an initial setup of the data protection appliance that identifies the data protection appliance as being placed in a vault, the vault being coupled by an air gap to a primary backup storage system, wherein upon the air gap being closed, backups at the primary backup storage system are replicated to the data protection appliance in the vault, and encrypted before being written to storage of the data protection appliance; receiving a request from a third-party scanning service to read the backups replicated to the data protection appliance in the vault; detecting the setting of the configuration parameter identifying the data protection appliance as being placed in the vault; and based on the detecting, disabling encryption of data segments responsive to the read request from the third-party scanning service, the third-party scanning service thereby being provided with the data segments in a clear test format, and the disabling of the encryption thereby allowing sharing of a decryption key for the backups with the third-party scanning service to be withheld.

Referring back now to FIG. 1, the clients may include servers, server machines, host machines, desktop computers, laptops, tablets, smartphones, internet of things (IoT) devices, or combinations of these. The network may be a cloud network, local area network (LAN), wide area network (WAN) or other appropriate network. The network provides connectivity to the various systems, components, and resources of the system, and may be implemented using protocols such as Transmission Control Protocol (TCP) and/or Internet Protocol (IP), well-known in the relevant arts. In a distributed network environment, the network may represent a cloud-based network environment in which applications, servers and data are maintained and provided through a centralized cloud computing platform. In an embodiment, the system may represent a multi-tenant network in which a server computer runs a single instance of a program serving multiple clients (tenants) in which the program is designed to virtually partition its data so that each client works with its own customized virtual application, with each virtual machine (VM) representing virtual clients that may be supported by one or more servers within each VM, or other type of centralized network server.

The storage system may include storage servers, clusters of storage servers, network storage device, storage device arrays, storage subsystems including RAID (Redundant Array of Independent Disks) components, a storage area network (SAN), Network-attached Storage (NAS), or Direct-attached Storage (DAS) that make use of large-scale network accessible storage devices, such as large capacity tape or drive (optical or magnetic) arrays, shared storage pool, or an object or cloud storage service. In an embodiment, storage (e.g., tape or disk array) may represent any practical storage device or set of devices, such as tape libraries, virtual tape libraries (VTL), fiber-channel (FC) storage area network devices, and OST (OpenStorage) devices. The storage may include any number of storage arrays having any number of disk arrays organized into logical unit numbers (LUNs). A LUN is a number or other identifier used to identify a logical storage unit. A disk may be configured as a single LUN or may include multiple disks. A LUN may include a portion of a disk, portions of multiple disks, or multiple complete disks. Thus, storage may represent logical storage that includes any number of physical storage devices connected to form a logical storage.

In an embodiment, the clients may be referred to as backup clients. In this embodiment, the filesystem provides a backup target for data generated by the clients. The backups are secondary copies that can be used in the event that primary file copies on the clients become unavailable due to, for example, data corruption, accidental deletion, natural disaster, data breaches, hacks, or other data loss event. The backups may be stored in a format such as a compressed format, deduplicated format, or encrypted format that is different from the native source format. In an embodiment, the filesystem is hosted by a cluster of nodes (e.g., two or more nodes). Depending on demand, cluster nodes or services may be dynamically scaled up or down. Thus, the cluster may be referred to as a scale out cluster. For example, as part of on-going operations, new nodes or new instances of a service may be added to the cluster or existing nodes or instances of a service may be removed from the cluster.

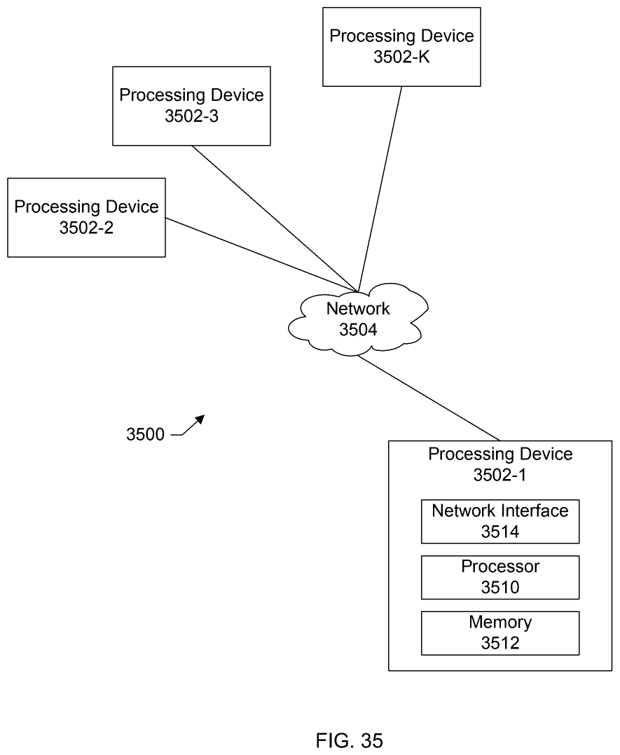

FIG. 35 shows an example of a processing platform 3500 that may include at least a portion of the information handling system shown in FIG. 1. The example shown in FIG. 35 includes a plurality of processing devices, denoted 3502-1, 3502-2, 3502-3, . . . 3502-K, which communicate with one another over a network 3504.

The network 3504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 3502-1 in the processing platform 3500 comprises a processor 3510 coupled to a memory 3512.

The processor 3510 may comprise a microprocessor, a microcontroller, an application-specific integrated circuit (A SIC), a field-programmable gate array (FPGA) or other type of processing circuitry, as well as portions or combinations of such circuitry elements.

The memory 3512 may comprise random access memory (RAM), read-only memory (ROM) or other types of memory, in any combination. The memory 3512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 3502-1 is network interface circuitry 3514, which is used to interface the processing device with the network 3504 and other system components, and may comprise conventional transceivers.

The other processing devices 3502 of the processing platform 3500 are assumed to be configured in a manner similar to that shown for processing device 3502-1 in the figure.

A gain, the particular processing platform 3500 shown in the figure is presented by way of example only, and the information handling system may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LX Cs.

As another example, portions of a given processing platform in some embodiments can comprise converged infrastructure such as VxRail™, VxRack™, VxRack™ FLEX, VxBlock™, or Vblock® converged infrastructure from VCE, the Virtual Computing Environment Company, now the Converged Platform and Solutions Division of Dell EMC.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality of one or more components of the compute services platform 100 are illustratively implemented in the form of software running on one or more processing devices.

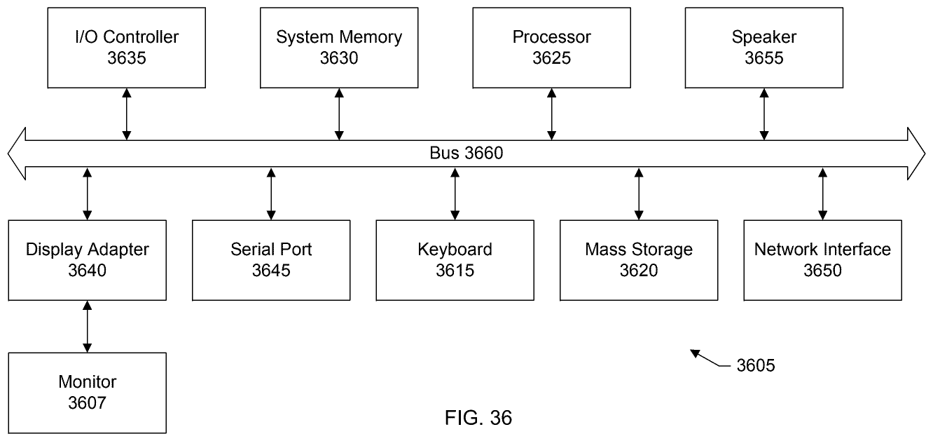

FIG. 36 shows a system block diagram of a computer system 3605 used to execute the software of the present system described herein. The computer system includes a monitor 3607, keyboard 3615, and mass storage devices 3620. Computer system 3605 further includes subsystems such as central processor 3625, system memory 3630, input/output (I/O) controller 3635, display adapter 3640, serial or universal serial bus (USB) port 3645, network interface 3650, and speaker 3655. The system may also be used with computer systems with additional or fewer subsystems. For example, a computer system could include more than one processor 3625 (i.e., a multiprocessor system) or a system may include a cache memory.

Arrows such as 3660 represent the system bus architecture of computer system 3605. However, these arrows are illustrative of any interconnection scheme serving to link the subsystems. For example, speaker 3655 could be connected to the other subsystems through a port or have an internal direct connection to central processor 3625. The processor may include multiple processors or a multicore processor, which may permit parallel processing of information. Computer system 3605 shown in FIG. 36 is but an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software.

An operating system for the system may be one of the Microsoft Windows®. family of systems (e.g., Windows Server), Linux, Mac OS X, IRIX 32, or IRIX 64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, 802.11ac, and 802.11ad, just to name a few examples), near field communication (NFC), radio-frequency identification (RFID), mobile or cellular wireless. For example, signals from a computer may be transferred, at least in part, wirelessly to components or other computers.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment. Other embodiments include systems and non-volatile media products that execute, embody or store processes that implement the methods described above.

What is claimed is:

1. A method comprising:
backing up a client by reading encrypted data segments from a primary storage of the client into a secure deduplication library installed at the client, the primary storage comprising a first data-at-rest-encryption (DARE) storage;
decrypting the encrypted data segments and deduplicating the now unencrypted data segments against existing data segments being managed by a data protection appliance, coupled to the client, to identify new data segments;
encrypting the new data segments and transmitting the encrypted new data segments to the data protection appliance, the data protection appliance comprising a deduplication filesystem, the deduplication filesystem comprising a secure deduplication layer above a storage layer, the storage layer comprising a second DARE storage; and
upon the secure deduplication layer receiving the encrypted new data segments, decrypting the encrypted new data segments, packing the now decrypted new data segments into storage containers, and writing the storage containers to the second DARE storage.

2. The method of claim 1 wherein a first key is associated with the first DARE storage, a second key is associated with the encrypting the new data segments and transmitting to the data protection appliance, and a third key is associated with the second DARE storage, and
wherein the first, second, and third keys are the same.

3. The method of claim 1 wherein a first key is associated with the first DARE storage, a second key is associated with the encrypting the new data segments and transmitting to the data protection appliance, and a third key is associated with the second DARE storage, and
wherein the first key is different from the second and third keys, and the second key is different from the third key.

4. The method of claim 1 further comprising:
receiving a restoration request from the client;
issuing read IOs from the secure deduplication layer to the storage layer comprising the second DARE storage for data segments responsive to the restoration;
encrypting the data segments responsive to the restoration before handing the now encrypted data segments responsive to the restoration to a namespace layer, above the secure deduplication layer, for transmission by a protocol layer, above the namespace layer, to the client;
upon receiving the encrypted data segments responsive to the restoration at the secure deduplication library at the client, decrypting the received data segments and validating the now decrypted received data segments; and
after the validating, encrypting the received data segments, and writing the received and now encrypted data segments to the first DARE storage.

5. The method of claim 1 wherein the backing up a client by reading encrypted data segments from a primary storage of the client into a secure deduplication library installed at the client comprises: loading data responsive to the backup into memory of the client, the data loaded into the memory being in an encrypted format.

6. The method of claim 1 wherein the writing the storage containers to the second DARE storage comprises encrypting the storage containers before writing to the second DARE storage.

7. A system comprising: a processor; and memory configured to store one or more sequences of instructions which, when executed by the processor, cause the processor to carry out the steps of:
backing up a client by reading encrypted data segments from a primary storage of the client into a secure deduplication library installed at the client, the primary storage comprising a first data-at-rest-encryption (DARE) storage;
decrypting the encrypted data segments and deduplicating the now unencrypted data segments against existing data segments being managed by a data protection appliance, coupled to the client, to identify new data segments;
encrypting the new data segments and transmitting the encrypted new data segments to the data protection appliance, the data protection appliance comprising a deduplication filesystem, the deduplication filesystem comprising a secure deduplication layer above a storage layer, the storage layer comprising a second DARE storage; and
upon the secure deduplication layer receiving the encrypted new data segments, decrypting the encrypted new data segments, packing the now decrypted new data segments into storage containers, and writing the storage containers to the second DARE storage.

8. The system of claim 7 wherein a first key is associated with the first DARE storage, a second key is associated with the encrypting the new data segments and transmitting to the data protection appliance, and a third key is associated with the second DARE storage, and
wherein the first, second, and third keys are the same.

9. The system of claim 7 wherein a first key is associated with the first DARE storage, a second key is associated with the encrypting the new data segments and transmitting to the data protection appliance, and a third key is associated with the second DARE storage, and
wherein the first key is different from the second and third keys, and the second key is different from the third key.

10. The system of claim 7 wherein the processor further carries out the steps of:
receiving a restoration request from the client;
issuing read IOs from the secure deduplication layer to the storage layer comprising the second DARE storage for data segments responsive to the restoration;
encrypting the data segments responsive to the restoration before handing the now encrypted data segments responsive to the restoration to a namespace layer, above the secure deduplication layer, for transmission by a protocol layer, above the namespace layer, to the client;
upon receiving the encrypted data segments responsive to the restoration at the secure deduplication library at the client, decrypting the received data segments and validating the now decrypted received data segments; and
after the validating, encrypting the received data segments, and writing the received and now encrypted data segments to the first DARE storage.

11. The system of claim 7 wherein the backing up a client by reading encrypted data segments from a primary storage of the client into a secure deduplication library installed at the client comprises: loading data responsive to the backup into memory of the client, the data loaded into the memory being in an encrypted format.

12. The system of claim 7 wherein the writing the storage containers to the second DARE storage comprises encrypting the storage containers before writing to the second DARE storage.

13. A computer program product, comprising a non-transitory computer-readable medium having a computer-readable program code embodied therein, the computer-readable program code adapted to be executed by one or more processors to implement a method comprising:
backing up a client by reading encrypted data segments from a primary storage of the client into a secure deduplication library installed at the client, the primary storage comprising a first data-at-rest-encryption (DARE) storage;
decrypting the encrypted data segments and deduplicating the now unencrypted data segments against existing data segments being managed by a data protection appliance, coupled to the client, to identify new data segments;
encrypting the new data segments and transmitting the encrypted new data segments to the data protection appliance, the data protection appliance comprising a deduplication filesystem, the deduplication filesystem comprising a secure deduplication layer above a storage layer, the storage layer comprising a second DARE storage; and
upon the secure deduplication layer receiving the encrypted new data segments, decrypting the encrypted new data segments, packing the now decrypted new data segments into storage containers, and writing the storage containers to the second DARE storage.

14. The computer program product of claim 13 wherein a first key is associated with the first DARE storage, a second key is associated with the encrypting the new data segments and transmitting to the data protection appliance, and a third key is associated with the second DARE storage, and
wherein the first, second, and third keys are the same.

15. The computer program product of claim 13 wherein a first key is associated with the first DARE storage, a second key is associated with the encrypting the new data segments and transmitting to the data protection appliance, and a third key is associated with the second DARE storage, and
wherein the first key is different from the second and third keys, and the second key is different from the third key.

16. The computer program product of claim 13 wherein the method further comprises:
receiving a restoration request from the client;
issuing read IOs from the secure deduplication layer to the storage layer comprising the second DARE storage for data segments responsive to the restoration;
encrypting the data segments responsive to the restoration before handing the now encrypted data segments responsive to the restoration to a namespace layer, above the secure deduplication layer, for transmission by a protocol layer, above the namespace layer, to the client;
upon receiving the encrypted data segments responsive to the restoration at the secure deduplication library at the client, decrypting the received data segments and validating the now decrypted received data segments; and
after the validating, encrypting the received data segments, and writing the received and now encrypted data segments to the first DARE storage.

17. The computer program product of claim 13 wherein the backing up a client by reading encrypted data segments from a primary storage of the client into a secure deduplication library installed at the client comprises: loading data responsive to the backup into memory of the client, the data loaded into the memory being in an encrypted format.

18. The computer program product of claim 13 wherein the writing the storage containers to the second DARE storage comprises encrypting the storage containers before writing to the second DARE storage.
